(19) United States
(12) Patent Application Publication
(10) Pub. No.: US 2026/0183161 A1
(43) Pub. Date: Jul. 2, 2026

(54) PATIENT SUPPORT APPARATUS MOVEMENT SYSTEM

(71) Applicant: Stryker Corporation, Portage, MI (US)

(72) Inventors: Ramsey H. Othman, Kalamazoo, MI (US); Tyler Joseph Ethen, Portage, MI (US); Michael W. Graves, Augusta, MI (US)

(21) Appl. No.: 19/432,431

(22) Filed: Dec. 24, 2025

Related U.S. Application Data
(60) Provisional application No. 63/740,726, filed on Dec. 31, 2024.

(51) Int. Cl. A61G 1/04; A61G 1/02

(52) U.S. Cl. CPC A61G 1/04; A61G 1/0281; A61G 2203/20; A61G 2203/32; A61G 2203/40

(57) ABSTRACT

A patient support apparatus system includes one or more patient support apparatuses, one or more location beacons, and, in some instances, a server. Each patient support apparatus includes a wireless transceiver adapted to range with the location beacon(s) to determine position information. The location beacon(s) transmit movement data, such as intersection data, corner data, speed limit data, and/or other data to the patient support apparatus. The patient support apparatus includes one or more powered wheels and it uses the movement data for controlling movement of the powered wheel and/or assisting the user of the patient support apparatus in the movement of the patient support apparatus. In some versions, the location beacon and/or server may be used to map areas of the healthcare facility where impacts above a threshold commonly occur, thereby allowing the patient support apparatus to automatically mitigate the impact forces during future visits to those areas.

### CROSS-REFERENCE TO RELATED APPLICATIONS

This application claims priority to U.S. provisional patent application Ser. No. 63/740,726 filed Dec. 31, 2024, by inventors Ramsey Othman et al. and entitled PATIENT SUPPORT APPARATUS MOVEMENT SYSTEM, the complete disclosure of which is incorporated herein by reference.

### BACKGROUND

The present disclosure relates to patient support apparatuses, such as beds, stretchers, cots, etc., and more particularly, to a movement system for such patient support apparatuses in a healthcare facility.

### SUMMARY

According to the various aspects described herein, the present disclosure is directed to a healthcare facility movement system that includes one or more location beacons that provide assistance to one or more patient support apparatuses as the patient support apparatuses move within the healthcare facility. The location beacons may provide movement data to the patient support apparatuses that includes, but is not limited to, intersection data, speed limit data, corner data, impact force data, and/or other data regarding the healthcare facility. The patient support apparatuses are configured to use the movement data to automatically control, and/or assist in the control of, the speed and/or steering of the patient support apparatuses as the patient support movement moves through one or more areas of the healthcare facility. Movement data may also be shared between patient support apparatuses themselves. The movement data helps the patient support apparatuses avoid collisions and/or steer around corners, provides an overall safer environment for people within the healthcare facility, and/or allows for more efficient and easy transport of patient support apparatuses. These and other aspects of the present disclosure will be apparent to one of ordinary skill in the art in light of the following written description and the accompanying drawings.

According to a first aspect of the present disclosure, a patient support apparatus is provided that includes a plurality of wheels, a support surface, a first wireless transceiver, a network transceiver, an accelerometer, and a controller. The support surface is adapted to support a patient thereon. The first wireless transceiver is adapted to range with a location beacon mounted at a fixed location within a healthcare facility and to determine a distance between the patient support apparatus and the location beacon. The network transceiver is adapted to wirelessly communicate with a server. The accelerometer is adapted to detect when the patient support apparatus experiences an impact force while the patient support apparatus is moving. The controller is adapted to transmit a message to the server via the network transceiver in response to the accelerometer detecting an impact force above a threshold. The message includes location data indicating a relative position of the patient support apparatus to the location beacon when the accelerometer detected the impact force above the threshold.

According to other aspects of the present disclosure, the controller is adapted to determine a direction of travel of the patient support apparatus relative to the location beacon at the moment the impact force above the threshold is detected.

In some aspects, the patient support apparatus includes a second wireless transceiver adapted to range with the location beacon and to determine a second distance between the patient support apparatus and the location beacon.

The patient support apparatus, in some aspects, includes a motor adapted to drive a powered wheel of the plurality of wheels.

The patient support apparatus, in some aspects, includes a memory in which the controller is adapted to store an impact location indicating a location of the patient support apparatus at the moment when the impact force above the threshold was detected.

In some aspects, the controller is adapted to compare the location data to past data stored in the memory. The past data includes location information regarding prior detections of impact forces over the threshold.

In some aspects, if the controller detects past data indicating an impact force above the threshold was previously detected at the same location as the impact location, the controller is adapted to automatically slow down the powered wheel in the future in response to the patient support apparatus moving to the same location as the impact location.

In some aspects, the controller is adapted to receive speed limit data from the location beacon and to limit a speed of the powered wheel in response to receipt of the speed limit data from the location beacon.

In some aspects, the patient support apparatus includes a first motor adapted to drive a powered wheel of the plurality of wheels and a second motor adapted to steer the patient support apparatus. The controller is adapted to receive steering data from the location beacon relating to steering of the patient support apparatus and to control the second motor in response to receipt of the steering data from the location beacon. The steering data may include intersection data and/or corner data.

The controller, in some aspects, is adapted to receive intersection data from the location beacon relating to an intersection near the location beacon. The intersection data informs the controller of a location of the intersection relative to the location beacon.

In some aspects, the controller is adapted to receive corner data from the location beacon relating to a corner near the location beacon. The corner data informs the controller of a degree of sharpness of the corner.

In some aspects, the controller is adapted to determine a first speed at which the powered wheel is moving and a second speed at which the distance between the patient support apparatus and the location beacon is changing.

The first wireless transceiver, in some aspects, is adapted to range with a second patient support apparatus and to determine a second distance between the patient support apparatus and the second patient support apparatus.

The controller, in some aspects, is adapted to determine a speed and direction of movement of the patient support apparatus within the healthcare facility and, if the second distance is less than a threshold, to transmit the speed and direction of movement to the second patient support apparatus.

The controller, in some aspects, is adapted to receive a speed and direction of movement of the second patient support apparatus within the healthcare facility and, if the second distance is less than a threshold, to adjust at least one of a speed or steering of the patient support apparatus.

In some aspects, the first wireless transceiver is an ultra-wideband (UWB) transceiver adapted to range with the location beacon and/or another patient support apparatus using UWB signals.

The patient support apparatus, in some aspects, includes a magnetometer adapted to be used by the controller to determine a geographic direction of travel of the patient support apparatus.

According to another aspect of the present disclosure a system for sharing movement information in a healthcare facility is provided. The system includes a patient support apparatus, a location beacon, and a server. The patient support apparatus includes a plurality of wheels, a support surface adapted to support a patient thereon, a first wireless transceiver adapted to range with the location beacon and to determine a distance between the patient support apparatus and the location beacon, a network transceiver adapted to communicate with the server, an accelerometer adapted to detect when the patient support apparatus experiences an impact force while the patient support apparatus is moving, and a controller adapted to transmit a message to the server via the network transceiver in response to the accelerometer detecting an impact force above a threshold. The message includes location data indicating a relative position of the patient support apparatus to the location beacon when the accelerometer detected the impact force above the threshold. The server is adapted to receive the message and store in a memory the location data.

According to other aspects of the present disclosure, the controller is adapted to determine a direction of travel of the patient support apparatus relative to the location beacon at the moment the impact force above the threshold is detected and to send the direction of travel to the server.

In some aspects, the patient support apparatus includes a motor adapted to drive a powered wheel of the plurality of wheels.

The server, in some aspects, is adapted to compare the location data to past data stored in the memory. The past data includes location information regarding prior detections of impact forces over the threshold by the patient support apparatus and/or other patient support apparatuses.

In some aspects, if the server detects past data indicating an impact force above the threshold was previously detected at the same location as the impact location, the server is adapted to automatically send a message to message to the patient support apparatus. The message instructs the patient support apparatus to slow down the powered wheel in the future in response to the patient support apparatus moving to the same location as the impact location.

In some aspects, the controller is adapted to transmit location messages to the server indicating a current location of the patient support apparatus relative to the location beacon. The controller is adapted to transmit the location messages regardless of the detection of any impact force.

The server, in some aspects, is adapted, in response to receipt of at least one of the location messages, to transmit speed limit data to the patient support apparatus and the controller is adapted to limit a speed of the powered wheel in response to receipt of the speed limit data.

In some aspects, the server is adapted, in response to receipt of at least one of the location messages, to transmit steering data to the patient support apparatus, and the controller is adapted to automatically adjust a steering of the patient support apparatus in response to receipt of the steering data.

In some aspects, the server is adapted to transmit intersection data to the patient support apparatus relating to an intersection near the location beacon and the controller is adapted to use the intersection data to control a speed of the patient support apparatus when traveling through the intersection.

The server, in some aspects, is adapted to transmit corner data to the patient support apparatus relating to a corner near the location beacon, and the controller is adapted to automatically assist in steering the patient support apparatus around the corner based on the corner data.

The server, in some aspects, is adapted to receive second location messages from a second patient support apparatus and to determine a distance between the patient support apparatus and the second patient support apparatus based upon the location messages and the second location messages.

The server, in some aspects, is adapted to determine a speed and direction of movement of the patient support apparatus within the healthcare facility and, if the second distance is less than a threshold, to transmit a current location of the patient support apparatus to the second patient support apparatus.

The first wireless transceiver, in some aspects, is an ultra-wideband (UWB) transceiver adapted to range with the location beacon and/or a second patient support apparatus using UWB signals.

In some aspects, the patient support apparatus includes a magnetometer adapted to be used by the controller to determine a geographic direction of travel of the patient support apparatus, and the controller is adapted to transmit the geographic direction to the server.

According to still another aspect of the present disclosure, a patient support apparatus is provided that includes a powered wheel, a motor adapted to drive the powered wheel, a support surface adapted to support a patient thereon, a first wireless transceiver, and a controller. The first wireless transceiver is adapted to range with a location beacon mounted at a fixed location within a healthcare facility and to determine a distance between the patient support apparatus and the location beacon. The controller is adapted to receive movement data from the location beacon. The movement data includes at least one of the following: (1) intersection data relating to an intersection in the healthcare facility; (2) corner data relating to a corner in the healthcare facility; or (3) speed limit data relating to a speed limit within the healthcare facility. The controller is adapted to automatically control driving of the powered wheel based at least partially upon receipt of the movement data.

According to still other aspects of the present disclosure, the intersection data includes first distance data indicating a first distance between the location beacon and the intersection, and the corner data includes second distance data indicating a second distance between the location beacon and the corner. The corner data may also indicate a degree of sharpness of the corner.

In some aspects, the speed limit data includes boundary data indicating a boundary of a location in which the speed limit applies.

The movement data, in some aspects, includes intersection data and the controller is adapted to automatically limit a speed of the patient support apparatus as the patient support apparatus moves through the intersection.

The movement data, in some aspects, includes speed limit data and the controller is adapted to automatically limit a speed of the patient support apparatus to a speed not exceeding the speed limit.

The movement data, in some aspects, includes corner data and the controller is adapted to automatically adjust steering of the patient support apparatus around the corner based upon the corner data.

The first wireless transceiver, in some aspects, is adapted to range with a second patient support apparatus and to determine a second distance between the patient support apparatus and the second patient support apparatus.

In some aspects, the controller is adapted to determine a speed and direction of movement of the patient support apparatus within the healthcare facility and, if the second distance is less than a threshold, to transmit the speed and direction of movement to the second patient support apparatus.

The controller, in some aspects, is adapted to receive a speed and direction of movement of the second patient support apparatus within the healthcare facility and, if the second distance is less than a threshold, to adjust at least one of a speed or steering of the patient support apparatus.

The first wireless transceiver, in some aspects, is an ultra-wideband (UWB) transceiver adapted to range with the location beacon and/or another patient support apparatus using UWB signals.

In some aspects, the patient support apparatus includes a magnetometer adapted to be used by the controller to determine a geographic direction of travel of the patient support apparatus.

In some aspects, the patient support apparatus includes an accelerometer and a network transceiver. The accelerometer is adapted to detect when the patient support apparatus experiences an impact force while the patient support apparatus is moving. The network transceiver is adapted to wirelessly communicate with a server. The controller is adapted to transmit a message to the server via the network transceiver in response to the accelerometer detecting an impact force above a threshold. The message includes impact data indicating an impact location of the patient support apparatus relative to the location beacon when the accelerometer detected the impact force above the threshold.

The controller, in some aspects, is adapted to determine a direction of travel of the patient support apparatus.

In some aspects, the patient support apparatus includes a memory in which the controller is adapted to store the impact location.

The controller, in some aspects, is adapted to compare the impact location to past data stored in the memory. The past data includes location information regarding prior detections of impact forces over the threshold by the patient support apparatus.

In some aspects, if the controller detects past data indicating an impact force above the threshold was previously detected at the same location as indicated in the impact location, the controller is adapted to automatically slow down the powered wheel in the future in response to the patient support apparatus moving to the same location as the impact location.

According to another aspect of the present disclosure, a location beacon mounted a fixed and known location within a healthcare facility is provided. The location beacon includes a housing adapted to be mounted to a wall, a first wireless transceiver, a memory, and a controller. The first wireless transceiver is adapted to range with a patient support apparatus and to determine a distance between the location beacon and the patient support apparatus. The memory includes movement data and a unique ID. The movement data includes at least one of the following: (1) intersection data relating to an intersection in the healthcare facility; (2) corner data relating to a corner in the healthcare facility; or (3) speed limit data relating to a speed limit within the healthcare facility. The controller is adapted to use the first wireless transceiver to transmit both the ID and the movement data to the patient support apparatus.

In some aspects, the controller is adapted to transmit the movement data to the patient support apparatus in response to the distance between the location beacon and the patient support apparatus falling to below a distance threshold, and to not transmit the movement data to the patient support apparatus in response to the distance between the location beacon and the patient support apparatus being above the distance threshold.

In some aspects, the controller is further adapted to determine a direction of travel of the patient support apparatus relative to the location beacon, and to transmit the movement data to the patient support apparatus when the patient support apparatus is moving in a first direction relative to the location beacon and to not transmit the movement data when the patient support apparatus is moving in a second direction relative to the location beacon.

In some aspects, the intersection data further includes first distance data indicating a first distance between the location beacon and the intersection, and the corner data includes second distance data indicating a second distance between the location beacon and the corner. The corner data may also indicate a degree of sharpness of the corner.

The speed limit data, in some aspects, includes boundary data indicating a boundary of a location in which the speed limit applies.

The movement data, in some aspects, includes the intersection data and the intersection data indicates a distance from the location beacon to the intersection.

The movement data, in some aspects, includes speed limit data and the speed limit data includes boundary data indicating a boundary of a location in which the speed limit applies.

In some aspects, the movement data includes corner data and the corner data includes both a distance between the location beacon and the corner and data indicating a degree of sharpness of the corner.

In some aspects, the first wireless transceiver is an ultra-wideband (UWB) transceiver adapted to range with the patient support apparatus using UWB signals.

The movement data, in some aspects, includes the intersection data, and the intersection data further includes geographic data indicating a geographic direction in which the intersection is located relative to the location beacon.

In some aspects, the movement data includes the corner data, and the corner data further includes geographic data indicating a geographic direction in which the corner is located relative to the location beacon.

The movement data, in some aspects, includes the speed limit data, and the speed limit data further includes geographic data indicating a geographic direction relative to the location beacon to an area in which the speed limit is applicable.

Before the various aspects of the disclosure are explained in detail, it is to be understood that the claims are not to be limited to the details of operation or to the details of construction and the arrangement of the components set forth in the following description or illustrated in the drawings. The aspects described herein are capable of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the claims to any specific order or number of components. Nor should the use of enumeration be construed as excluding from the scope of the claims any additional steps or components that might be combined with or into the enumerated steps or components.

### BRIEF DESCRIPTION OF THE DRAWINGS

FIG. 1 is a perspective view of a patient support apparatus according to a first aspect of the present disclosure;

FIG. 2 is a plan view of a control panel of the patient support apparatus;

FIG. 3 is an elevational view of the patient support apparatus of FIG. 1 better illustrating a built-in propulsion system;

FIG. 4 is a perspective view of a throttle of the propulsion system;

FIG. 5 is a perspective view of a movement system according to a first aspect of the present disclosure, including a location beacon, a patient support apparatus, and a server, as well as several components that may interact with the movement system;

FIG. 6 is a block diagram of the patient support apparatus, location beacon, and server of FIG. 5;

FIG. 7 is a plan view of a floorplan of an illustrative healthcare facility showing a patient support apparatus and a plurality of location beacons;

FIG. 8 is a plan view of an illustrative corner of a healthcare facility illustrating a first manner in which movement information may assist in the steering of the patient support apparatus;

FIG. 9 is a plan view of an illustrative corner of a healthcare facility illustrating a second manner in which movement information may assist in the steering of the patient support apparatus;

FIG. 10 is a plan view of an illustrative corner of a healthcare facility illustrating a third manner in which movement information may assist in the steering of the patient support apparatus; and

FIG. 11 is a plan view of an illustrative corner of a healthcare facility illustrating a fourth manner in which movement information may assist in the steering of the patient support apparatus;

### DETAILED DESCRIPTION OF THE DISCLOSURE

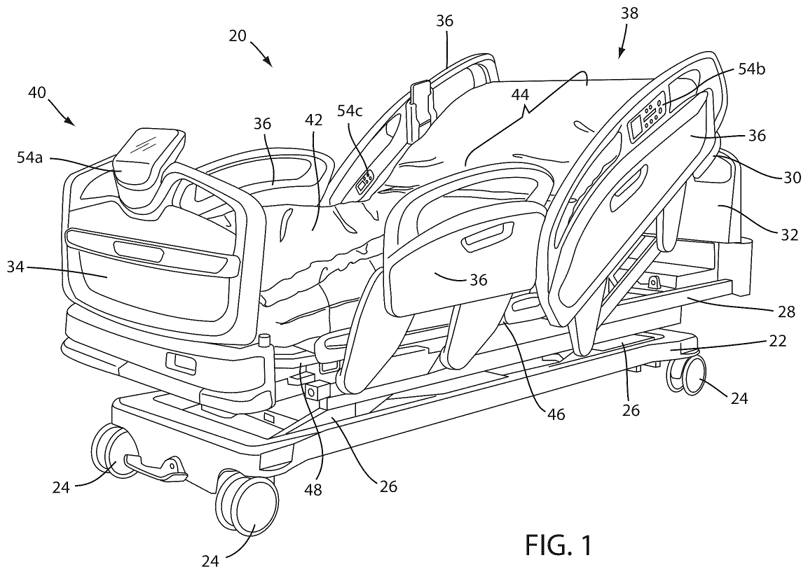

An illustrative patient support apparatus 20 that may be part of a movement system 150 of the present disclosure is shown in FIG. 1. Although the particular form of patient support apparatus 20 illustrated in FIG. 1 is a bed adapted for use in a hospital or other medical setting, it will be understood that patient support apparatus 20 could, in different versions, be a cot, a stretcher, a recliner, or any other mobile structure capable of supporting a patient in a healthcare environment.

In general, patient support apparatus 20 includes a base 22 having a plurality of wheels 24, a pair of lifts 26 supported on the base 22, a litter frame 28 supported on the lifts 26, and a support deck 30 supported on the litter frame 28. Patient support apparatus 20 further includes a headboard 32, a footboard 34 and a plurality of siderails 36. Siderails 36 are all shown in a raised position in FIG. 1 but are each individually movable to a lower position in which ingress into, and egress out of, patient support apparatus 20 is not obstructed by the lowered siderails 36.

Lifts 26 are adapted to raise and lower litter frame 28 with respect to base 22. Lifts 26 may be hydraulic actuators, electric actuators, or any other suitable device for raising and lowering litter frame 28 with respect to base 22. In the illustrated version, lifts 26 are operable independently so that the tilting of litter frame 28 with respect to base 22 can also be adjusted, to place the litter frame 28 in a flat or horizontal orientation, a Trendelenburg orientation, or a reverse Trendelenburg orientation. That is, litter frame 28 includes a head end 38 and a foot end 40, each of whose height can be independently adjusted by the nearest lift 26. Patient support apparatus 20 is designed so that when an occupant lies thereon, his or her head will be positioned adjacent head end 38 and his or her feet will be positioned adjacent foot end 40.

Litter frame 28 provides a structure for supporting support deck 30, the headboard 32, footboard 34, and siderails 36. Support deck 30 provides a support surface for a mattress 42, or other soft cushion, so that a person may lie and/or sit thereon. In some versions, the mattress 42 includes one or more inflatable bladders that are controllable via a blower, or other source of pressurized air. In at least one version, the inflation of the bladders of the mattress 42 is controllable via electronics built into patient support apparatus 20. In one such versions, mattress 42 may take on any of the functions and/or structures of any of the mattresses disclosed in commonly assigned U.S. Pat. No. 9,468,307 issued Oct. 18, 2016, to inventors Patrick Lafleche et al., the complete disclosure of which is incorporated herein by reference. Still other types of mattresses may be used.

Support deck 30 is made of a plurality of sections, some of which are pivotable about generally horizontal pivot axes. In the version shown in FIG. 1, support deck 30 includes at least a head section 44, a thigh section 46, and a foot section 48, all of which are positioned underneath mattress 42 and which generally form flat surfaces for supporting mattress 42. Head section 44, which is also sometimes referred to as a Fowler section, is pivotable about a generally horizontal pivot axis between a generally horizontal orientation (not shown in FIG. 1) and a plurality of raised positions (one of which is shown in FIG. 1). Thigh section 46 and foot section 48 may also be pivotable about generally horizontal pivot axes.

It will be understood by those skilled in the art that patient support apparatus 20 can be designed with other types of mechanical constructions that are different from what is shown in the attached drawings, such as, but not limited to, the construction described in commonly assigned, U.S. Pat. No. 10,130,536 to Roussy et al., entitled PATIENT SUPPORT USABLE WITH BARIATRIC PATIENTS, the complete disclosure of which is incorporated herein by reference. In another version, the mechanical construction of patient support apparatus 20 may include the same, or nearly the same, structures as the Model 3002 S3 bed manufactured and sold by Stryker Corporation of Kalamazoo, Michigan. This construction is described in greater detail in the Stryker Maintenance Manual for the MedSurg Bed, Model 3002 S3, published in 2010 by Stryker Corporation of Kalamazoo, Michigan, the complete disclosure of which is incorporated herein by reference. In still another version, the mechanical construction of patient support apparatus 20 may include the same, or nearly the same, structure as the Model 3009 Procuity MedSurg bed manufactured and sold by Stryker Corporation of Kalamazoo, Michigan. This construction is described in greater detail in the Stryker Maintenance Manual for the 3009 Procuity MedSurg bed (publication 3009-009-002, Rev. A.0), published in 2020 by Stryker Corporation of Kalamazoo, Michigan.

It will be understood by those skilled in the art that patient support apparatus 20 can be designed with still other types of mechanical constructions, such as, but not limited to, those described in commonly assigned, U.S. Pat. No. 7,690,59 issued Apr. 6, 2010, to Lemire et al., and entitled HOSPITAL BED; and/or commonly assigned U.S. Pat. publication No. 2007/0163045 filed by Becker et al. and entitled PATIENT HANDLING DEVICE INCLUDING LOCAL STATUS INDICATION, ONE-TOUCH FOWLER ANGLE ADJUSTMENT, AND POWER-ON ALARM CONFIGURATION, the complete disclosures of both of which are also hereby incorporated herein by reference. The overall mechanical construction of patient support apparatus 20 may also take on still other forms different from what is disclosed in the aforementioned references provided the patient support apparatus includes one or more of the functions, features, and/or structures discussed in greater detail below.

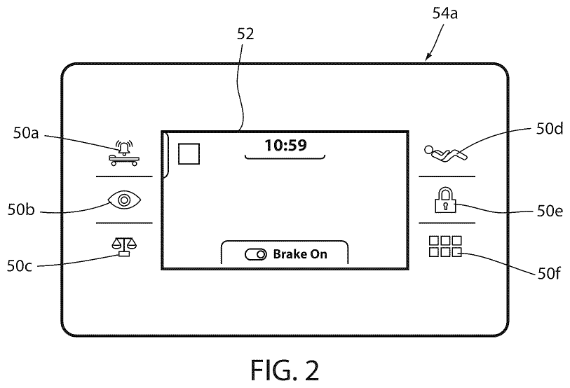

Patient support apparatus 20 further includes a plurality of control panels 54 that enable a user of patient support apparatus 20, such as a patient and/or an associated caregiver, to control one or more aspects of patient support apparatus 20. In the version shown in FIG. 1, patient support apparatus 20 includes a footboard control panel 54a, a pair of outer siderail control panels 54b (only one of which is visible), and a pair of inner siderail control panels 54c (only one of which is visible). Footboard control panel 54a and outer siderail control panels 54b are intended to be used by caregivers, or other authorized personnel, while inner siderail control panels 54c are intended to be used by the patient associated with patient support apparatus 20. Each of the control panels 54 includes a plurality of controls 50 (see, e.g., FIG. 2), although each control panel 54 does not necessarily include the same controls and/or functionality.

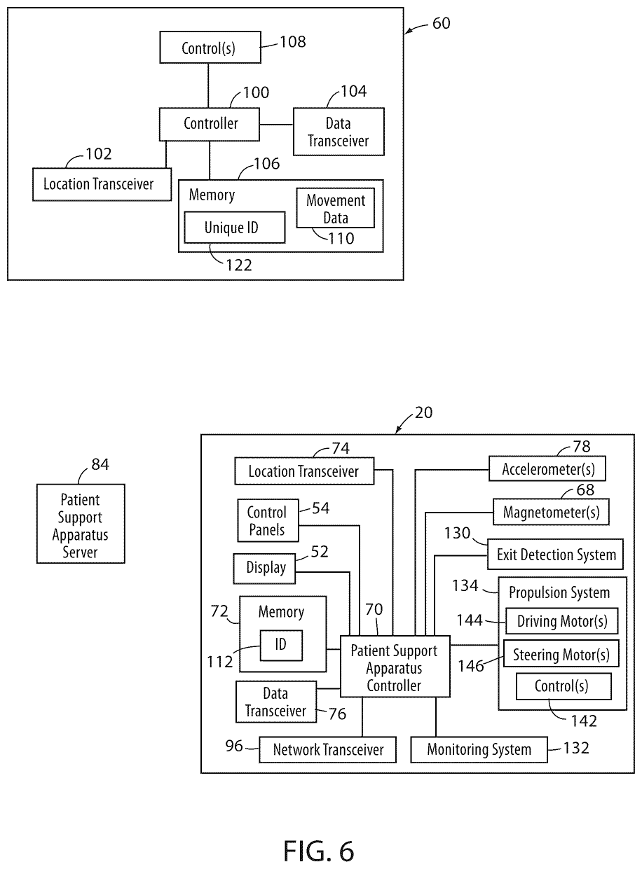

Among other functions, controls 50 of control panel 54a allow a user to control one or more of the following: change a height of support deck 30; raise or lower head section 44; activate and deactivate a brake for wheels 24; arm and disarm an exit detection system 130 and/or an onboard monitoring system 132 (FIG. 6); control a built-in propulsion system 134; change various settings on patient support apparatus 20; and perform other actions.

Control panel 54a includes a display 52 (FIG. 2) configured to display a plurality of different screens thereon. Surrounding display 52 are a plurality of navigation controls 50a-f that, when activated, cause the display 52 to display different screens on display 52. More specifically, when a user presses navigation control 50a, control panel 54a displays an exit detection control screen on display 52 that includes one or more icons that, when touched, control the onboard exit detection system 130 (FIG. 6). The exit detection system 130 is as adapted to issue an alert when a patient exits from patient support apparatus 20. Exit detection system 130 may include any of the same features and functions as, and/or may be constructed in any of the same manners as, the exit detection system disclosed in commonly assigned U.S. patent application 62/889,254 filed Aug. 20, 2019, by inventors Sujay Sukumaran et al. and entitled PERSON SUPPORT APPARATUS WITH ADJUSTABLE EXIT DETECTION ZONES, the complete disclosure of which is incorporated herein by reference. Other types of exit detection systems may be included within patient support apparatus 20.

When a user presses navigation control 50b (FIG. 2), control panel 54 displays a monitoring control screen that includes a plurality of control icons that, when touched, control the onboard multi-component monitoring system 132 (FIG. 6) built into patient support apparatus 20. The onboard monitoring system 132 alerts the caregiver through one or more unified indicators, such as lights or a plurality of lights controlled in a unified manner, when any one of a plurality of settings and/or components on patient support apparatus 20 are in an undesired state, and uses the same unified indicator(s) to indicate when all of the plurality of settings and/or components are in their respective desired states. Stated alternatively, monitoring system 132, when armed, monitors a plurality of conditions of patient support apparatus 20 (such as, but not limited to, any one or more of the following: brake status, siderail position, litter frame height, exit detection system 130, A/C cord status, nurse call cable status, etc.) and issues an alert if any one of those conditions are in an undesired state. Further details of one type of monitoring system that may be built into patient support apparatus 20 are disclosed in commonly assigned U.S. patent application Ser. No. 62/864,638 filed Jun. 21, 2019, by inventors Kurosh Nahavandi et al. and entitled PATIENT SUPPORT APPARATUS WITH CAREGIVER REMINDERS, as well as commonly assigned U.S. patent application Ser. No. 16/721,133 filed Dec. 19, 2019, by inventors Kurosh Nahavandi et al. and entitled PATIENT SUPPORT APPARATUSES WITH MOTION CUSTOMIZATION, the complete disclosures of both of which are incorporated herein by reference. Other types of monitoring systems may be included within patient support apparatus 20.

When a user presses navigation control 50c, control panel 54a displays a scale control screen that includes a plurality of control icons that, when touched, control a scale system (not shown) of patient support apparatus 20. Such a scale system may include any of the same features and functions as, and/or may be constructed in any of the same manners as, the scale systems disclosed in commonly assigned U.S. patent application 62/889,254 filed Aug. 20, 2019, by inventors Sujay Sukumaran et al. and entitled PERSON SUPPORT APPARATUS WITH ADJUSTABLE EXIT DETECTION ZONES, and U.S. patent application Ser. No. 62/885,954 filed Aug. 13, 2019, by inventors Kurosh Nahavandi et al. and entitled PATIENT SUPPORT APPARATUS WITH EQUIPMENT WEIGHT LOG, the complete disclosures of both of which are incorporated herein by reference. The scale system may utilize the same force sensors and/or other components that are utilized by the exit detection system 130, or it may utilize one or more different sensors and/or other components. Other scale systems besides those mentioned above in the '254 and '954 applications may alternatively be included within patient support apparatus 20.

When a user presses navigation control 50d, control panel 54 displays a motion control screen that includes a plurality of control icons that, when touched, control the movement of various components of patient support apparatus 20, such as, but not limited to, the height of litter frame 28 and the pivoting of head section 44. In some versions, the motion control screen displayed on display 52 in response to pressing control 50d may be the same as, or similar to, the position control screen 216 disclosed in commonly assigned U.S. patent application Ser. No. 62/885,953 filed Aug. 13, 2019, by inventors Kurosh Nahavandi et al. and entitled PATIENT SUPPORT APPARATUS WITH TOUCHSCREEN, the complete disclosure of which is incorporated herein by reference. Other types of motion control screens may be included on patient support apparatus 20.

When a user presses navigation control 50e, control panel 54a displays a motion lock control screen that includes a plurality of control icons that, when touched, control one or more motion lockout functions of patient support apparatus 20. Such motion lockout functions typically include the ability for a caregiver to use control panel 54a to lock out one or more of the motion controls 50 of the patient control panels 54c such that the patient is not able to use those controls 50 on control panels 54c to control the movement of one or more components of patient support apparatus 20. The motion lockout screen may include any of the features and functions as, and/or may be constructed in any of the same manners as, the motion lockout features, functions, and constructions disclosed in commonly assigned U.S. patent application Ser. No. 16/721,133 filed Dec. 19, 2019, by inventors Kurosh Nahavandi et al. and entitled PATIENT SUPPORT APPARATUSES WITH MOTION CUSTOMIZATION, the complete disclosure of which is incorporated herein by reference. Other types of motion lockouts may be included within patient support apparatus 20.

When a user presses on navigation control 50f, control panel 54a displays a menu screen that includes a plurality of menu icons that, when touched, bring up one or more additional screens for controlling and/or viewing one or more other aspects of patient support apparatus 20. Such other aspects include, but are not limited to, displaying diagnostic and/or service information for patient support apparatus 20, displaying mattress control and/or status information, and configuration settings, location information, and other settings and/or information.

For all of the navigation controls 50a-f (FIG. 2), screens other than the ones specifically mentioned above may be displayed on display 52 in other versions of patient support apparatus 20 in response to a user pressing these controls. Thus, it will be understood that the specific screens mentioned above are merely representative of the types of screens that are displayable on display 52 in response to a user pressing on one or more of navigation controls 50a-f. It will also be understood that, although navigation controls 50a-f have all been illustrated in the accompanying drawings as dedicated controls that are positioned adjacent display 52, any one or more of these controls 50a-f could alternatively be touchscreen controls that are displayed at one or more locations on display 52. Still further, although controls 50a-f have been shown herein as buttons, it will be understood that any of controls 50a-f could also, or alternatively, be switches, dials, or other types of non-button controls. Additionally, patient support apparatus 20 may be modified to include additional, fewer, and/or different navigation controls from the navigation controls 50a-f shown in FIG. 2.

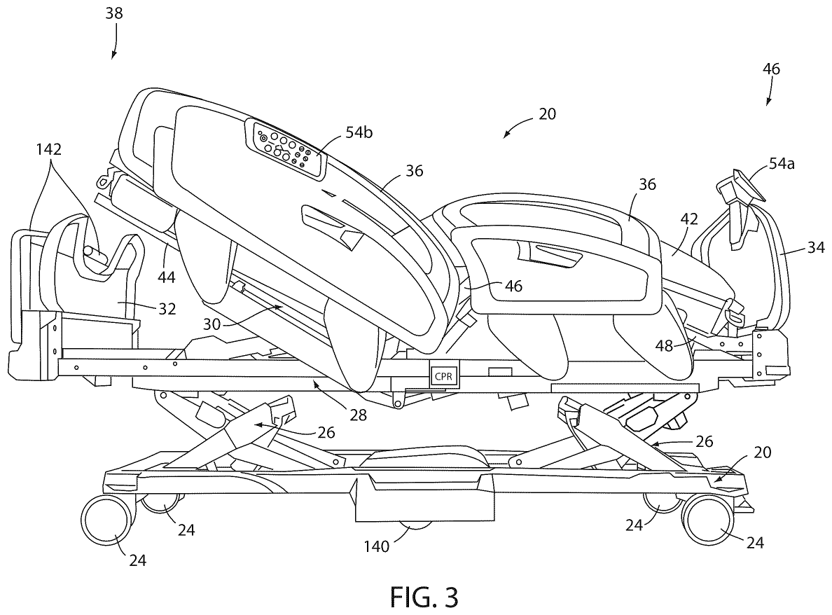

FIG. 3 illustrates patient support apparatus 20 of FIG. 1 from a different angle that enables several components of propulsion system 134 to be more clearly seen. Specifically, as shown in FIG. 3, propulsion system 134 includes at least one powered wheel 140 and one or more propulsion controls 142. As shown in FIG. 6, propulsion system 134 further includes at least one driving motor 144 and, in some versions, as least one steering motor 146. As will be discussed in greater detail below, powered wheel 140 is adapted to be lifted out of contact with the floor and lowered into contact with the floor. When lowered into contact with the floor, powered wheel 140 is adapted to be driven by driving motor 144, thereby reducing the force that a caregiver would otherwise need to apply to patient support apparatus 20 in order to get patient support apparatus 20 to move across the floor. In some versions, the caregiver must manually steer patient support apparatus 20 while powered wheel 140 is being driven. In other versions, the steering and/or driving may be fully autonomous, thereby eliminating the need for a caregiver to steer and/or push on patient support apparatus 20 to get it to move. In any version, patient support apparatus 20 may be configured to automatically make adjustments to the steering and/or speed of the patient support apparatus 20 based on movement information it receives from one or more location beacons 60, other patient support apparatuses 20, and/or a patient support apparatus server 84.

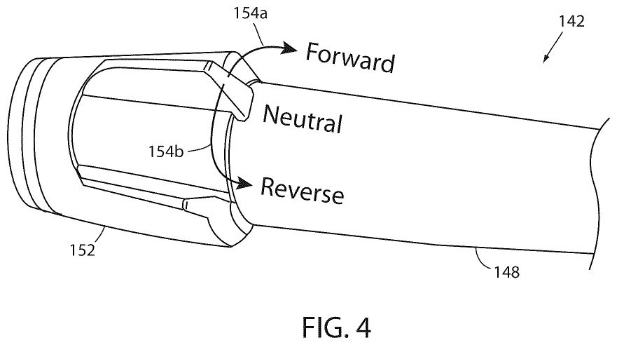

FIG. 4 illustrates an example of one manner in which a propulsion control 142 may be implemented. As shown therein, propulsion control 142 includes a handle 148 having a rotatable throttle 152 positioned at its distal end. When throttle 152 is rotated in a forward direction indicated by arrow 154a, patient support apparatus 20 drives powered wheel 140 in a direction that moves patient support apparatus 20 forward. When a caregiver rotates throttle 152 in a rearward direction, as indicated by arrow 154b, patient support apparatus 20 drives powered wheel 140 in a direction that moves patient support apparatus 20 backwards. When a caregiver leaves throttle 152 in a neutral position, patient support apparatus 20 does not drive powered wheel 140 in any direction. In the particular example shown in FIG. 3, there are two propulsion controls 142 on either side of head end 38 of patient support apparatus 20, and the caregiver is free to use either control 142. In some versions, controls 142 may be adapted to be used simultaneously wherein, if the caregiver rotates one throttle 152 more than the other throttle 152, the powered wheel(s) 140 will rotate about a generally vertical axis, thereby assisting the caregiver in steering patient support apparatus 20. In other words, in some versions, a caregiver can apply different driving forces via throttles 152 to different sides of patient support apparatus 20, thereby causing patient support apparatus 20 not only drive forward, but to also turn.

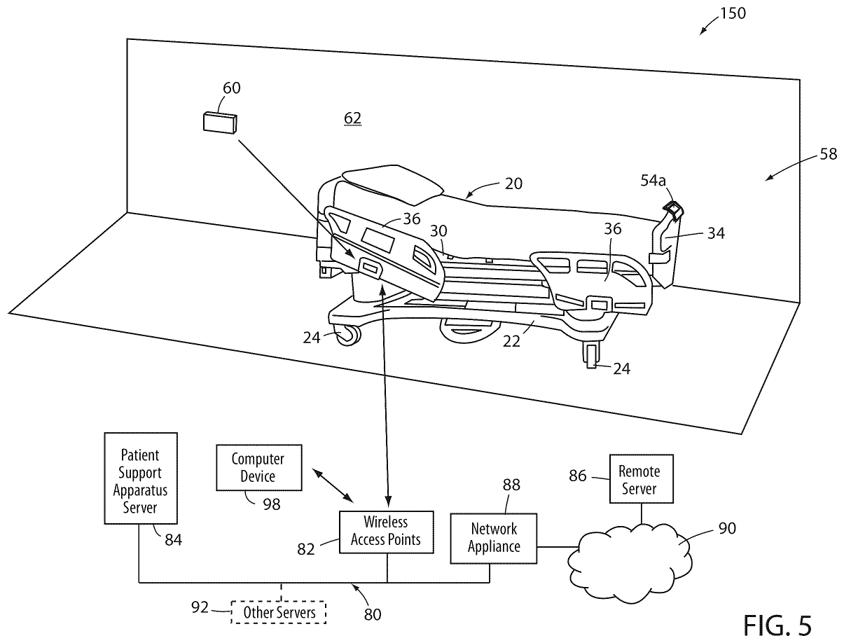

FIG. 5 illustrates a one example of a movement system 150 integrated into a healthcare facility according to one aspect of the present disclosure. As will be discussed more below, the movement system 150 includes one or more location beacons 60 that, in at least some versions, are able to communicate with a patient support apparatus server 84 and/or one or more patient support apparatuses 20. As shown in FIG. 5, patient support apparatus 20 is positioned within a hallway 58 of a healthcare facility. Patient support apparatus 20 is configured to communicate with location beacon 60 and, in some versions, a conventional local area network 80 of the healthcare facility. Location beacons 60 are fixed devices that can be positioned at various locations throughout the healthcare facility. As will be discussed in greater detail below, each location beacon 60 may provide both an indication of its location within the healthcare facility, as well as movement information that can be useful for the movement of one or more patient support apparatuses 20 through one or more areas of the healthcare facility.

Each location beacon 60 (FIG. 5) is adapted to wirelessly communicate with one or more nearby patient support apparatuses 20 and provide them with a unique ID of the location beacon 60. As will be discussed in greater detail below, once the patient support apparatus 20 has the unique ID from the location beacon 60, either the patient support apparatus 20 can determine its location from the unique ID and/or forward the unique ID to patient support apparatus server 84 (or a remote server 86), and patient support apparatus server 84 (or remote server 86), can use that unique ID to determine the location of the patient support apparatus 20. Information from the patient support apparatus 20 can then be associated with a particular location within the healthcare facility, and when such information is shared with one or more recipients, the location of the patient support apparatus 20 can be included in the information so that the recipient knows where patient support apparatus 20 is currently located.

Location beacons 60 are adapted to be fixed to one or more walls 62 and/or other structures within the healthcare facility. After the installation of one or more location beacons 60, the positions of those location beacons 60 is determined via surveying operation carried out by authorized individuals. The results of this surveying operation may then be input and stored in patient support apparatus server 84 and/or onboard each patient support apparatus 20, thereby allowing server 84 and/or patient support apparatuses 20 to determine their location from a unique ID 122 they receive from a nearby fixed location beacon.

As is also shown in FIG. 5, patient support apparatus 20 is configured to communicate with a local area network 80 of the healthcare facility. In at least one version, patient support apparatus 20 includes a wireless network transceiver 96 (FIG. 6) that communicates wirelessly with local area network 80. Network transceiver 96 is, in at least some versions, a WiFi transceiver (e.g., IEEE 802.11) that wirelessly communicates with one or more conventional wireless access points 82 of local area network 80. In other versions, network transceiver 96 may be a wireless transceiver that uses conventional 5G technology to communicate with network 80, one or more servers hosted thereon, and/or other devices. In some versions, network transceiver 96 may include any of the structures and/or functionality of the communication modules 56 disclosed in commonly assigned U.S. Pat. No. 10,500,401 issued to Michael Hayes and entitled NETWORK COMMUNICATION FOR PATIENT SUPPORT APPARATUSES, the complete disclosure of which is incorporated herein by reference. Still other types of wireless network transceivers may be utilized.

In some versions, network transceiver 96 is a wired transceiver that is adapted to allow patient support apparatus 20 to communicate with network 80 via a wired connection, such as an Ethernet cable that plugs into an Ethernet port (e.g., an RJ-45 style port, an 8P8C port, etc.) built into patient support apparatus 20. In still other versions, patient support apparatus 20 includes both a wired transceiver 96 for communicating with network 80 via a wired connection and a wireless transceiver 96 for wirelessly communicating with network 80.

Patient support apparatus 20 may be configured to communicate with one or more servers on local area network 80 of the healthcare facility (FIG. 5). One such server is patient support apparatus server 84. Patient support apparatus server 84 is adapted, in at least one version, to receive data from the patient support apparatuses 20 positioned within the healthcare facility and distribute this data to caregivers, other servers, and/or other software applications. As noted, patient support apparatus server 84 may also be configured to determine the location of patient support apparatuses 20 that are positioned adjacent to a location beacon 60. Still further, patient support apparatus server 84 may be configured to store and/or share movement data relating to the movement of patient support apparatuses 20 within the healthcare facility.

In some versions, patient support apparatus server 84 may be replaced and/or supplemented by a remote server 86 that is positioned geographically remotely from the healthcare facility. Communication between patient support apparatus server 84 and remote server 86 may take place via a conventional network appliance 88, such as, but not limited to, a router and/or a gateway, which is coupled to the Internet 90. The remote server 86, in turn, is also coupled to the Internet 90, and patient support apparatus server 84 is provided with the URL and/or other information necessary to communicate with remote server 86 via the Internet connection between network 80 and server 86.

As noted, in some versions of movement system 150, any or all of the functions of patient support apparatus server 84 described herein may be moved to one or more cloud-based servers, such as remote server 86. That is, in some versions, the data from patient support apparatuses 20 may be sent to remote server 86 without relying upon any locally hosted servers on network 80, such as patient support apparatus server 84 (which may be omitted). In such versions of system 150, patient support apparatuses 20 may include one or more appropriate device managers that enable them to communicate with one or more cloud-based servers. Such cloud-based server(s) may be hosted on Amazon Web Services, Google's Cloud Services, other commercially available cloud services, and/or on private cloud service. In such cases, patient support apparatuses 20 are provided with the URL and/or other information necessary to communicate with remote server 86 via the Internet connection between network 80 and remote server 86. Still other types of direct-to-cloud connections may be utilized with one or more of patient support apparatuses 20.

Patient support apparatus server 84 (FIG. 5) is configured to determine the location of one or more patient support apparatuses 20, share movement data with one or more patient support apparatuses 20, and/or store movement data received from one or more patient support apparatuses 20. In some versions, patient support apparatus server 84 determines the room number, bay area, hallway, section of a hallway, maintenance area, and/or any other particular location of a patient support apparatus 20. As will be discussed in greater detail below, patient support apparatus server 84 may be configured to determine the position of any patient support apparatus 20 that is positioned within communication range of one or more location beacons 60. In some versions, patient support apparatus server 84 may also be configured to receive, process, and/or distribute status data received from one or more patient support apparatuses 20. Such status data may include, but is not limited to, status data indicating a state of a brake onboard patient support apparatus 20, status data indicating positions of siderails 36, status data indicating a state of exit detection system 130, status data indicating a state of monitoring system 132, status data indicating a height of litter frame 28, and/or still other status data.

It will be understood that the architecture and content of local area network 80 beyond patient support apparatus server 84 and/or remote server 86 will vary from healthcare facility to healthcare facility, and that the example shown in FIG. 5 is a simplified version of the type of network a healthcare facility may be employ. Typically, one or more additional servers 92 will be hosted on network 80 and one or more of them may be adapted to communicate with patient support apparatus server 84 and/or remote server 86. Local area network 80 will also typically be in communication with one or more computer device 98 (e.g. via WiFi) via access points 82. Patient support apparatus server 84 and/or remote server 86 may be configured to send location information and/or device information to one or more of these computer devices 98 informing appropriate personnel of the status and/or location of patient support apparatuses 20. Such computer devices 98 include, but are not limited to, smart phones, tablet computers, portable laptops, desktop computers, and other types of electronic devices that include a WiFi capability (or other network access capability) and that are provided with the proper credentials (e.g., SSID, password, etc.) to access network 80 and patient support apparatus server 84.

The additional servers 92 may include a conventional badge server, a conventional EMR server, a conventional Admission, Discharge, and Transfer (ADT) server, and/or a conventional caregiver assignment server. Alternatively, patient support apparatus server 84 and/or badge server 94 may be combined, either partially or wholly, with any one or more of these other servers. Further information about these servers may be found in commonly assigned U.S. patent application Ser. No. 63/717,921 filed Nov. 8, 2024, by inventors Lavanya Vytla et al. and entitled PATIENT SUPPORT APPARATUS WITH EVENT LOGGING, the complete disclosure of which is incorporated herein by reference.

Turning to FIG. 6, one version of movement system 150 is shown in block diagram format, illustrating several of the internal components of the devices that may be included within system 150. As shown in FIG. 6, movement system 150 includes a location beacon 60, a patient support apparatus 20, and patient support apparatus server 84 (or remote server 86). Although FIG. 6 depicts the internal components of only a single location beacon 60 and a single patient support apparatus 20, it will be understood that more than one of any of these devices may be included in different versions of movement system 150.

In the example shown in FIG. 6, location beacon 60 includes a controller 100, a location transceiver 102, a data transceiver 104, a memory 106, and one or more controls 108. Controller 100 is adapted to communicate with, and control, the other components of location beacon 60 in the manners described herein.

Location transceiver 102 (FIG. 6) is adapted to communicate with patient support apparatus 20 in a manner that allows the current location of patient support apparatus 20 to be determined (by patient support apparatus 20 itself, by patient support apparatus server 84, and/or by another device). In some versions, this communication enables a relative position and/or an absolute position of patient support apparatus 20 to be determined. In terms of a relative position, location transceiver 102 may communicate with patient support apparatus 20 in a manner that allows a distance to be determined between location transceiver 102 and a patient support apparatus 20. In some versions, this communication may also enable angular relationships to be determined between location beacon 60 and one or more patient support apparatuses 20. From this distance and/or angle information, the relative position of patient support apparatus 20 to a location beacon 60 can be determined.

As was noted, in some versions, the communication between location transceiver 102 and patient support apparatus 20 may also allow for the absolute position of patient support apparatus 20 within the overall healthcare facility to be determined. In order to determine the absolute position of patient support apparatus 20 within the healthcare facility, location beacon 60 may transmit unique ID 122 to a nearby patient support apparatus 20 (using location transceiver 102 and/or data transceiver 104), in which case patient support apparatus 20 and/or patient support apparatus server 84 can determine the overall location of patient support apparatus 20 within the healthcare facility. That is, patient support apparatus 20 and/or patient support apparatus server 84 use unique ID 122 to conclude that patient support apparatus 20 is positioned relatively close to location beacon 60, and that the location of location beacon 60 can therefore serve as a proxy for the overall location of patient support apparatus 20 within the healthcare facility. In other words, location transceiver 102 may be used to determine if patient support apparatus 20 is positioned sufficiently close to the location beacon 60 such that the patient support apparatus 20 can be considered to be at the same location as the location beacon 60.

In some versions of patient support apparatus 20, location transceiver 102 may be an ultra-wideband transceiver, which enables a distance and/or angular information between location beacon 60 and patient support apparatus 20 to be determined. In other versions, location transceiver 102 may be an infrared transceiver or a Bluetooth transceiver (in the latter case, data transceiver 76 may be omitted or implemented as a non-Bluetooth transceiver in order to avoid redundant Bluetooth transceivers). In some versions, one or more of the functions of location transceiver 102 may be combined with data transceiver 104.

Data transceiver 104 (FIG. 6), if included, may be a Bluetooth transceiver adapted to communicate with one or more Bluetooth transceivers onboard one or more patient support apparatuses 20 using RF waves in accordance with conventional Bluetooth standards (e.g., IEEE 802.14.1 and/or any of the standards maintained by the Bluetooth Special Interest Group (SIG) of Kirkland, Washington, USA). In some versions, Bluetooth transceiver 104 utilizes Bluetooth Low Energy communications. As will be discussed in greater detail below, Bluetooth transceiver 104 may be configured to transmit unique ID 122 and/or movement data to one or more patient support apparatuses 20, and/or to receive movement data from one or more patient support apparatuses 20 and/or other sources (e.g. server 84).

Memory 106 may be any conventional memory such as, but not limited to, a flash memory, RAM, ROM, EEPROM, etc. Memory 106 may store the software and/or firmware that is executed by controller 100 in order to carry out the functions described herein. As was noted, memory 106 also stores a unique ID 122. Still further, memory 106 may store movement data 110. As will be discussed in greater detail below, movement data 110 may include data regarding any nearby intersections, corners, speed limits, obstacles, and/or other things that may be helpful for patient support apparatus 20 to be safely, smoothly, and efficiently moved through one or more areas of the healthcare facility.

Controls 108 (FIG. 6) of movable beacon may include any one or more structures used to control one or more aspects of location beacon 60. Such structures include, but are not limited to, buttons, switches, dials, pressure sensors, capacitive sensors, touchscreen icons, keypads, etc. Controls 108, if included, allow a user to control one or more features of location beacon 60. Such controllable features may include, for example, the input, editing, and/or deletion of movement data 110.

Unique ID 122 is an identifier that uniquely identifies a particular location beacon 60, thereby allowing it to be distinguished from other location beacons 60 that may be positioned within the same healthcare facility. In some versions of location beacon 60, unique ID 122 is stored in memory 106, while in other versions, it may be stored separately. In some versions, unique ID 122 may be static ID that is not changeable by a user. In other versions, unique ID 122 may be changeable by a user. In both versions, controller 100 is configured to transmit the unique ID 122 to a patient support apparatus 20 when the patient support apparatus 20 is positioned within relatively close proximity to the location beacon 60. Patient support apparatus 20 then either determines its location from the unique ID 122 (using a table that indicates the location of that particular location beacon 60), or sends the unique ID 122 to patient support apparatus server 84 (or server 86), which determines the location of the patient support apparatus 20 from the unique ID 122 (using a table that indicates the location of that particular location beacon 60). The table is generated by appropriate healthcare workers at the time of, or subsequent to, the installation of one or more location beacons 60 at particular locations within the healthcare facility. That is, the appropriate healthcare worker enters the particular location of each installed location beacon 60 into one or more of patient support apparatus server 84, patient support apparatus 20, or the location beacon 60 itself.

It will be understood that one or more of the components of location beacon 60 shown in FIG. 6 may be omitted, supplemented, and/or changed from what is shown therein. For example, location beacon 60, in some versions, may include a network transceiver adapted to communicate with local area network 80, patient support apparatus server 84, and/or remote server 86. Additionally, or alternatively, location beacon 60 may include a magnetometer, one or more additional location transceiver 102, and/or additional data regarding the orientation of location beacon 60 within the healthcare facility (e.g. a geographic direction it is facing). Location beacon 60 may also be modified to omit one or more of controls 108. Further, as noted, data transceiver 104 and location transceiver 102 may be combined into a single transceiver. In some versions, location beacon 60 may include any of the directionality-finding, wall-side determining, shielding, and/or other functions of the wall units 60 disclosed in commonly assigned U.S. patent application Ser. No. 18/572,678 filed Sep. 15, 2022, by inventors Kirby Neihouser et al. and entitled SYSTEM FOR LOCATING PATIENT SUPPORT APPARATUSES, the complete disclosure of which is incorporated herein by reference.

In some versions, location beacon 60 may include circuitry enabling it to communicatively couple to a conventional nurse call outlet, which is often a 37-pin outlet that enables communications between patient support apparatus 20 and a conventional nurse call system (as well as a reading light, room light, and/or nearby television) to take place. In some versions, location beacon 60 may also include any of the features and/or functionality of any of the headwall units 76 disclosed in commonly assigned U.S. patent application Ser. No. 16/215,911 filed Dec. 11, 2018, by inventors Alexander Bodurka et al. and entitled HOSPITAL HEADWALL COMMUNICATION SYSTEM, the complete disclosure of which is incorporated herein by reference. Alternatively, or additionally, location beacons 60 may include any and/or all of the same functionality as, and/or components of, the headwall interface 38 disclosed in commonly assigned U.S. patent publication 2016/0038361 published Feb. 11, 2016, entitled PATIENT SUPPORT APPARATUSES WITH WIRELESS HEADWALL COMMUNICATION, and filed by inventors Krishna Bhimavarapu et al., the complete disclosure of which is also incorporated herein by reference. Still further, location beacons 60 and/or patient support apparatus 20 may include any of the functionality and/or components of the headwall units 140, 140a and/or patient support apparatuses 20, 20a, and/or 20b disclosed in commonly assigned U.S. patent application Ser. No. 62/833,943 filed Apr. 15, 2019, by inventors Alexander Bodurka et al. and entitled PATIENT SUPPORT APPARATUSES WITH NURSE CALL AUDIO MANAGEMENT, the complete disclosure of which is incorporated herein by reference.

Patient support apparatus 20, as illustrated in FIG. 6, includes a controller 70, a memory 72, a location transceiver 74, a data transceiver 76, one or more accelerometers 78, and one or more magnetometers 68. Patient support apparatus 20, as illustrated in FIG. 6, also includes network transceiver 96, control panel(s) 54, display 52, exit detection system 130, monitoring system 132, and a plurality of additional components that are not shown in FIG. 6.

Memory 72 includes an ID 112 that uniquely identifies patient support apparatus 20 and distinguishes patient support apparatus 20 from other patient support apparatuses 20. Controller 70 is adapted to include ID 112 in the messages transmitted to other devices (e.g. location beacon 60 and/or patient support apparatus server 84) so that the recipient device knows the particular patient support apparatus 20 that transmitted the message. This enables location beacon 60 and/or patient support apparatus 20 to distinguish between communications with one patient support apparatus 20 versus another patient support apparatus 20.

Location transceiver 74 is configured to communicate with the location transceiver 102 of a nearby location beacon 60. In some versions, location transceivers 74 and 102 are UWB transceivers that are adapted to determine their distance from each other and, if the distance is less than a threshold, controller 70 is configured to consider itself associated with that particular location beacon 60. Once associated, controller 70 reports its location to patient support apparatus server 84 (via network transceiver 96) as corresponding to the location of that particular location beacon 60. In some versions, the threshold distance is on the order of zero to several meters, although other distances may be used as the threshold. In other versions, location transceivers 74 and 102 may be infrared transceivers adapted to perform line-of-sight communications, which is a proxy for proximity. Further details regarding the use of short range infrared communications for location determination are described in commonly assigned U.S. Pat. No. 9,999,375 issued Jun. 19, 2018, to inventors Michael Hayes et al. and entitled LOCATION DETECTION SYSTEMS AND METHODS, the complete disclosure of which is incorporated herein by reference.

In still other versions, location transceivers 74 and 102 may be UWB transceivers or Bluetooth transceivers that are used to determine the relative position of patient support apparatus 20 to one or more location beacons 60. When location transceiver 74 is a Bluetooth transceiver, data transceiver 76 may either be omitted or implemented as another type (i.e. non-Bluetooth) of transceiver. In other words, in different versions of location beacon 60 and/or patient support apparatus 20, one or more of the location and data transceivers illustrated in FIG. 6 may be eliminated and their functions performed by one or more of the other remaining transceivers.

Data transceiver 76 is adapted to transmit data to and/or receive data from, data transceiver 104 of location beacon 60, if included on location beacon 60. Such data communication may include any of the movement data 110 and/or unique ID 122. In some versions of patient support apparatus 20, data transceiver 76 is a Bluetooth transceiver.

Network transceiver 96 (FIG. 6) may be a WiFi transceiver (e.g., IEEE 802.11) that wirelessly communicates with one or more conventional wireless access points 82 of local area network 80. In other versions of patient support apparatus 20, network transceiver 96 may be a wireless transceiver that uses conventional 5G technology to communicate with network 80, one or more servers hosted thereon, and/or other devices. In some versions, network transceiver 96 may include any of the structures and/or functionality of the communication modules 56 disclosed in commonly assigned U.S. Pat. No. 10,500,401 issued to Michael Hayes and entitled NETWORK COMMUNICATION FOR PATIENT SUPPORT APPARATUSES, the complete disclosure of which is incorporated herein by reference. Still other types of wireless or wired network transceivers may be utilized.

When patient support apparatus 20 includes one or more accelerometers 78, each accelerometer 78 may be a conventional accelerometer. Accelerometer(s) 78 may be positioned at any suitable locations on patient support apparatus 20. In some versions, accelerometer(s) 78 are used by controller 70 of patient support apparatus 20 to detect when impact forces are exerted on patient support apparatus 20. Such impact forces may be due to patient support apparats 20 moving over a bump in a hallway or other location within the healthcare facility, they may be due to patient support apparatus 20 bumping into another structure (or person, or other patient support apparatus 20) within the healthcare facility, or they may be due to other impacts forces that are exerted against patient support apparatus 20. Accelerometer(s) 78 output a signal that is correlated to the amplitude of the impact force it detects and this signal is processed by controller 70, as will be discussed in greater detail below.

Magnetometer 68 (FIG. 6) may include one or more conventional magnetometers that sense a geographic orientation of patient support apparatus 20 relative to magnetic north. In some versions, magnetometers 68 may be replaced and/or supplemented with one or more inertial reference units, gyroscopes, and/or other navigation equipment that enables controller 70 to determine the position and/or orientation of patient support apparatus 20 within the healthcare facility, either alone or in conjunction with other position information (e.g. positioned information derived from one or more location beacons 60).

Controller 70 of patient support apparatus 20, as well as controller 100 of location beacon 60, may take on a variety of different forms. For example, each of these controllers 70 and/or 100 may be implemented as conventional microcontrollers. However, these controllers may be modified to use a variety of other types of circuits—either alone or in combination with one or more microcontrollers—such as, but not limited to, any one or more microprocessors, field programmable gate arrays, systems on a chip, volatile or nonvolatile memory, discrete circuitry, and/or other hardware, software, or firmware that is capable of carrying out the functions described herein, as would be known to one of ordinary skill in the art. Such components can be physically configured in any suitable manner, such as by mounting them to one or more circuit boards, or arranging them in other manners, whether combined into a single unit or distributed across multiple units. The instructions followed by controllers 70 and/or 100 when carrying out the functions described herein, as well as the data necessary for carrying out these functions, are stored in a corresponding memory that is accessible to that particular controller (e.g. memory 106 for controller 100; memory 72 for controller 70). In some versions, controllers 70 and/or 100 may include and/or work with one or more microcontrollers that are integrated into, or associated with, the Bluetooth and/or UWB transceiver(s) aboard that particular device.

Controller 100 of location beacon 60 is configured to automatically share its unique ID 122 with any patient support apparatus 20 (and, in some versions, one or more other mobile electronic devices) if the patient support apparatus 20 (or other device) are within communication range of location beacon 60. In some versions, patient support apparatus 20 is configured to send out an interrogation message in response to one or more triggering actions, and location beacon 60, if it is close enough to receive the interrogation message, is configured to respond with its unique ID 122. The triggering conditions for sending out the interrogation message may be varied. In some versions of patient support apparatus 20, the triggering conditions may include any one or more of the following: the activation of a brake onboard patient support apparatus 20, the plugging in of an AC power cord of the patient support apparatus 20 into an electrical outlet; movement of patient support apparatus 20 (such as by propulsion system 134) from one location to another; and/or other triggering conditions.

In some versions of location beacon 60, controller 100 may be configured to periodically send out an interrogation message and/or a message containing its unique ID 122 to any patient support apparatuses 20 that are within communication range. In those versions of location beacon 60 that utilize one or more UWB transceivers, controller 100 may be configured to first determine the relative distance between itself and a patient support apparatus 20 and, if the distance is less than a threshold, to then send out its unique ID 122 to the patient support apparatus 20. Alternatively, or additionally, controller 100 may be configured to first determine the relative distance, orientation, and/or movement of a patient support apparatus 20 relative to location beacon 60 and, if the distance, orientation, and/or movement of patient support apparatus 20 relative to location beacon 60 meets one or more criteria, to then send out movement data 110 to the patient support apparatus 20.

In any of the versions described herein, once patient support apparatus 20 receives a unique ID 122 from a location beacon 60, controller 70 is configured to either consult an onboard table that correlates the unique ID 122 to a specific location within the healthcare facility, and/or to send the unique ID 122 to patient support apparatus server 84, which contains a table correlating the unique ID to a specific location within the healthcare facility. In either situation, the data in the correlation table is manually input into either the patient support apparatus 20 and/or the patient support apparatus server 84.

Alternatively, in some versions of location beacon 60, the unique ID 122 may itself indicate the absolute position of the location beacon 60 within the healthcare facility (e.g. room 402). In such versions, once the patient support apparatus 20 receives the unique ID 122, the patient support apparatus 20 is informed of its location within the healthcare facility and does not need to consult a table correlating the location ID 122 to a specific location within the healthcare facility. This is because the unique ID 122 itself describes the location of the location beacon 60.

When location transceivers 74 and 102 are UWB transceivers, and patient support apparatus 20 includes more than one UWB transceiver, each UWB transceiver onboard patient support apparatus 20 is positioned at a known location on patient support apparatus 20. This known location information is stored in memory 72 and/or elsewhere, and may be defined with respect to any suitable frame of reference that is common to patient support apparatus 20. The known location information may include the spatial relationship between the UWB transceivers 74 and/or any other components of patient support apparatus 20. For example, in some versions, the known location information includes the spatial relationship not only between UWB transceivers 74, but also the spatial relationships between UWB transceivers 74 and one or more of the following: the head end 38 of patient support apparatus 20, the foot end 40 of patient support apparatus 20, the sides of patient support apparatus 20, a reference point defined on patient support apparatus 20, the floor, and/or other components and/or landmarks of patient support apparatus 20. In some versions, this location information is used to determine the orientation of patient support apparatus 20 with respect to one or more walls 62, location beacons 60, other patient support apparatuses 20, and/or other objects or structures within the healthcare facility.

In some versions of location beacon 60 and/or patient support apparatus 20, the location of the patient support apparatus 20 and/or other mobile device may be determined from communication with multiple location beacons 60. That is, in some versions of patient support apparatus 20 (or other mobile devices), the location may be determined utilizing triangulation and/or trilateration with more than one location beacon 60 and/or with one or more access points 82 of known position via WiFi (network transceiver 96). For example, in at least one version of patient support apparatuses 20, the location of the patient support apparatus 20 may be determined in any of the manners disclosed in commonly assigned Indian patent application serial number 202411097963, filed Dec. 11, 2024, by inventors Celso Pereira et al. and entitled HEALTHCARE FACILITY LOCATION SYSTEM, the complete disclosure of which is incorporated herein by reference.

When location transceivers 74 and 102 are implemented as ultra-wideband transceivers, the UWB transceivers may be configured to determine the distance between themselves using time of flight (ToF) computations. In other versions, the UWB transceivers 74 and 102 may utilize other techniques (e.g., time difference of arrival, two-way ranging, angle of arrival, channel state information, etc.) for determining their distances from each other, either in addition to, or in lieu of, ToF computations. In some versions, UWB transceivers 74 and 102 may also determine an angle between themselves using angular information derived from antenna arrays positions onboard transceivers 74 and 102, or by using other techniques. The position and orientation of each UWB transceiver 74 onboard patient support apparatus 20 (if there is more than one) may be stored in memory 72 and used to determine the position and orientation of patient support apparatus 20 with respect to the location beacon(s) 60 with which it is communicating. Such position and orientation information may be determined using conventional trilateration and/or triangulation techniques, or other techniques.

In some versions of movement system 150 in which location transceivers 74 and 102 are UWB transceivers, the UWB transceivers 74 and 102 may be implemented as any of the Trimension™ ultra-wideband modules available from NXP Semiconductors of Austin, Texas. These modules include, but are not limited to, the Trimension™ UWB modules ASMOP1BO0N1, ASMOP1CO0R1, and/or the ASMOP1CO0A1, that utilize any of the following chips: the NXP SR150, SR100T, SR040, NCJ29D5, and/or the OL23DO chips. Modules manufactured and/or marketed by other companies may also be used, including, but not limited to, the Decawave DWM1000, DWM10001C, DWM3000 modules (available from Decawave of Dublin, Ireland); the Nordic TSG5162 SiP module (available from Tsingoal Technology of Beijing, China); and/or the UWB hub, wand, and/or sensors available from Zebra technologies of Lincolnshire, Illinois. Still other types of UWB modules may be used.

In those versions of movement system 150 that include one or more UWB transceivers (e.g. UWB transceivers 74 and 102), the UWB transceivers may operate in the same manner as, and include any of the same functions as, the anchors and pseudo-anchors disclosed in commonly assigned U.S. patent application Ser. No. 63/193,777 filed May 27, 2021, by inventors Thomas Deeds et al. and entitled SYSTEM FOR ASSOCIATING MEDICAL DEVICE DATA, the complete disclosure of which has already been incorporated herein by reference.

It will be understood that one or more of the components of the patient support apparatus 20 shown in FIG. 6 may be omitted, supplemented, and/or changed from what is shown therein. For example, patient support apparatus 20, in some versions, may omit any one or more of exit detection system 130, monitoring system 132, display 52, magnetometer 68, accelerometer 78, and/or other components. One or more additional components may also, or alternatively, be added to patient support apparatus 20.

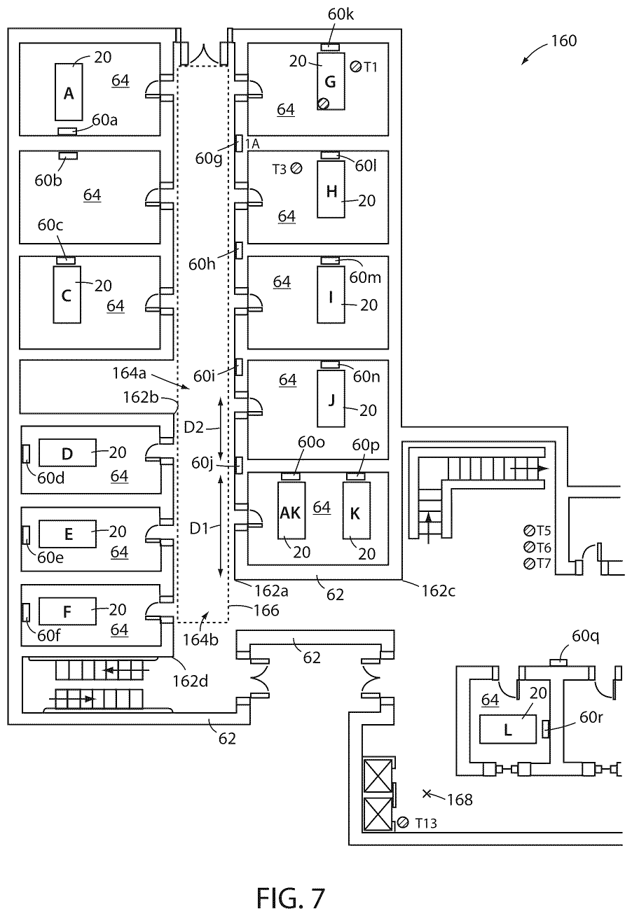

FIG. 7 shows an illustrative example of a portion of a healthcare facility floor plan 160. In this example, the healthcare facility includes a plurality of rooms 64 and a plurality of location beacons 60 positioned at various locations throughout the healthcare facility. Typically, each room 64 of the healthcare facility may include a location beacon 60. Additional location beacons 60 are also positioned along hallways through the healthcare facility. As will be discussed, it may also be desirable to position location beacons 60 near one or more intersections, corners, high-traffic areas, and/or other areas where it may be desirable to reduce the maximum speed of the patient support apparatuses 20.

At least some of the location beacons 60 in the healthcare facility may include movement data 110 stored in their respective memories 106. In some situations, the location beacons 60 located within individual rooms 64 may not include movement data 110, or may include reduced amounts of movement data 110. In generally, the movement data 110 that is stored in any particular location beacon 60 provides information regarding the movement of patient support apparatuses 20 through one or more areas that are near that particular location beacon 60. Thus, for example, a first location beacon 60 located near a first hallway intersection may store and share movement data 110 that relates to that first hallway intersection while a second location beacon 60 located near a second hallway intersection may store and share movement data 110 that relates to that second hallway intersection. In this scenario, if the first and second hallway intersections are positioned at different areas of the healthcare facility, the first location beacon 60 may not include any of the movement data 110 relating to the second hallway intersection and the second location beacon 60 may not include any of the movement data 110 relating to the first hallway intersection. In general, each location beacon 60 may include movement data 110 that relates to areas of the healthcare facility that are within reliable communication range of that particular location beacon 60. If location beacons 60 are implemented using ultra-wideband communications, then this may result in communication ranges of five to thirty meters, although other ranges may, of course, be utilized.

In general, the movement data 110 (FIG. 6) may include any one or more of the following:
intersection data, speed limit data, corner data, impact data, wall data, and/or other data. The intersection data may specify a location of an intersection 164 (FIG. 7). The speed limit data may specify a maximum speed that patient support apparatuses 20 are allowed to move through a particular area 166 of the healthcare facility. The corner data may specify the location and degree of sharpness (e.g. the angle) of a corner 162. The impact data may specify a location of an impact area 168 within the healthcare facility where, due to discontinues in the floor, one or more obstacles, or other factors, the patient support apparatuses 20 tend to experience high force impacts in that area 168. Still other movement data 110 may be stored within one or more location beacons 60.

The movement data 110 stored within a location beacon is stored, in some versions, in a manner that specifies the applicable location of the movement data relative to that particular location beacon 60. For example, in the example of FIG. 7, location beacon 60j may include movement data 110 that includes intersection data relating to intersection 162b, and this intersection data may include a distance D1 that indicates the distance from location beacon 60j to intersection 162b. In addition, the intersection data may include directional information specifying the direction of intersection 162b relative to location beacon 60j (e.g. intersection 162b is located due south of location beacon 60j). Because patient support apparatuses 20 are configured to determine their distance from location beacons 60, once a patient support apparatus 20 knows how far away it is from location beacon 60j, it can determine its distance from the nearby intersection 164. As will be discussed more below, this enables controller 70 of patient support apparatus 20 to automatically adjust its speed, as appropriate, as it approaches and/or travels through intersection 162b.

In some versions, movement data 110 may include additional data regarding an intersection 164, such as, but not limited to, any one or more of the following: data regarding a speed limit for the intersection, data regarding the type of intersection (e.g. a three-way intersection, a four-way intersection, etc.), data regarding a width of each of the hallways that intersect, data regarding the angle(s) formed by the intersecting hallways, data regarding which side of the hallway the healthcare facility administrators may want the patient support apparatus 20 to travel on while approaching and/or traveling through the intersection 164, and/or still other data regarding the intersection.

In the example shown in FIG. 7, location beacon 60j may also store intersection data that includes the distance D2 to intersection 162a, as well as the direction from location beacon 60j to intersection 162a. Still further, location beacon 60j may store still other intersection data and/or other movement data 110.

In those situations where a location beacon 60 includes speed limit data as part of its movement data 110, the speed limit data includes a maximum permissible speed for patient support apparatuses 20 that are traveling through a defined area 166. Movement data 110 may include both the maximum permissible speed and the data defining the speed limit area 166. The data defining the speed limit area 166 may be defined in different manners. For example, the speed limit area 166 may be defined as any area within a specific distance of the location beacon 60, or any area within a specific distance and direction of the location beacon 60. Alternatively, the speed limit area 166 may be defined with respect to a coordinate frame of reference and that coordinate frame of reference, in some versions, may be integrated with one or more other location beacons 60. In other words, in some versions, multiple location beacons 60 may be positioned at known positions within a common coordinate frame of reference, and patient support apparatuses 20 may determine their distances from one or more of these location beacons 60 to determine either or both their own location within the coordinate frame of reference and the location of speed limit area 166 within the coordinate frame of reference.

In those situations where a location beacon 60 includes corner data as part of its movement data, the corner data may define the location of one or more corners relative the location beacon 60. The location is defined, in some versions, as a distance from the location beacon 60 and a direction of that distance. The corner data may also define a degree of sharpness of the corner, such as the angle at which the hallway turns (or intersects another hallway). This degree of sharpness of the corner may be specified by an angle. In some situations, additional corner data may be included that, in addition to, or in lieu of, the angle information, specifies a radius of curvature of the corner (if the corner is curved). The corner data may also specify the width of the hallway at or near the corner and/or still other information.

In those situations where a location beacon 60 includes impact data, the impact data may specify not only an impact location 168 (FIG. 7), but information defining a nature of the impact location. The impact location 168 may be specified in any of the same manners as the other movement data (e.g. a distance and direction from the location beacon 60, a location within a coordinate frame of reference, etc.). The nature of the impact location may include information such as the following: a bump, a beginning of a ramp, an end of a ramp, a previous collision site, a doorway, etc. In general, the nature of the impact location informs patient support apparatus 20 of the nature of an impact that may occur at the impact location. In some versions of patient support apparatus 20, controller 70 may automatically steer around this location, adjust its speed, display impact location to the user on display 52, and/or take other actions.

In those situations where a location beacon 60 includes wall data, the wall data may define the location of one or more walls 62 relative to the location beacon 60. Such wall data may include any one or more of the following: data defining which wall of a hallway the location beacon 60 is positioned at (e.g. west side of a hallway, data defining the width of a hallway, data defining the angular direction and extent of the walls 62 on one or both sides of a hallway (e.g. hallway X is Y meters wide and oriented at 5 degrees (from north)), data defining a height of the location beacon 60 on a wall 62, and/or other data relating to the walls 62 and/or hallway near the location beacon 60. As will be discussed in greater detail below, patient support apparatus 20 may use this information to automatically steer patient support apparatus 20 in a manner that avoids and/or mitigates any collisions with any of walls 62.

Each location beacon 60 is configured to transmit some or all of its movement data 110 to a patient support apparatus 20 when the patient support apparatus 20 is positioned within reliable communication range of the location beacon 60, or, in some other versions, when the patient support apparatus 20 moves within a threshold distance of the location beacon 60. With respect to the former version, controller 100 is configured to transmit movement data 110 to each patient support apparatus 20 it is able to reliably communicate with. With respect to the latter version, after establishing communication with a patient support apparatus 20, controller 100 uses location transceiver 102 to repetitively determine the distance to the patient support apparatus 20. Controller 100 compares each repetitively determined distance to a distance threshold and, if the measured distance is less than the distance threshold, controller 100 transmits its movement data 110 to the patient support apparatus 20. If the repetitively determined distance does not fall below the distance threshold, controller 100 does not transmit its movement data 110 to the patient support apparatus 20.

In addition to ranging with location beacons 60, controller 70 of patient support apparatus 20 may also location transceiver 74 to range with the location transceivers 74 of other patient support apparatuses 20 that are within communication range. In some versions, as will be discussed in more detail below, this ranging enables a first patient support apparatus 20 to know its distance from a second patient support apparatus 20. In some versions, each patient support apparatus 20 is configured to automatically exchange additional movement data if they are within a threshold distance of each other. For example, if first and second patient support apparatuses 20 are within a threshold distance of each other, controller 70 of each patient support apparatus 20 may automatically inform the controller 70 of the other patient support apparatus 20 its respective speed and direction. The direction of each patient support apparatus 20 may be determined from its onboard magnetometer 68. Its speed may be determined from one or more sensors built into powered wheel 140 and/or other wheels 24. Other manners of determining the speed and/or direction of a patient support apparatus 20 may also, or alternatively, be used. As will be discussed in greater detail below, each patient support apparatus 20 may use the speed and direction information it receives from the other patient support apparatus 20 to automatically adjust its speed and/or heading in order to reduce and/or avoid the likelihood of a collision between the two patient support apparatuses.

In some versions of patient support apparatus 20, controller 70 is configured to monitor the outputs from one or more of accelerometers 78 to determine when an impact force against patient support apparatus 20 is detected that exceeds a threshold. Such impacts may be due to a variety of different activities, including, but not limited to, patient support apparatus 20 traveling over a bump, discontinuity, pothole, or the like, on the floor; patient support apparatus 20 colliding with another object (e.g. wall, obstacle, person, door, other patient support apparatus 20, etc.), and/or patient support apparatus 20 being hit by a movable object (e.g. another patient support apparatus 20, a person, etc.). When controller 70 detects an impact force above the threshold, it is adapted to automatically record a location of the impact in its memory 72. The location may be an absolute location within the healthcare facility, or it may be a relative location (e.g. a distance and/or direction from one or more nearby location beacons 60).

Controller 70 is also adapted to automatically send this impact location to patient support apparatus server 84 (or remote server 86), which in turn saves this impact location in its own memory. Server 84 (or 86) then compares this impact location to any previous impact locations that it may have stored in its memory from pervious impacts detected by that same patient support apparatus 20, as well as any other patient support apparatus 20 within the healthcare facility. If the server 84 (or 86) determines that more than one impacts exceeding the threshold have occurred at the same location, it may classify the location as a high impact location and take steps to reduce and/or avoid future impacts occurring at that same location.

The steps that server 84 or 86 may take include one or more of the following: informing each of the patient support apparatuses 20 within the healthcare facility of the location of the high impact location; instructing one or more location beacons 60 to add the high impact location to their movement data 110 for sharing with nearby patient support apparatuses 20; and/or monitor the locations of each patient support apparatus 20 and send data defining the high impact location to any patient support apparatuses 20 that are near the high impact location. When server 84 (or 86) sends data to a location beacon 60, each location beacon 60 may include its own network transceiver, thereby enabling each location beacon 60 to receive updates to its movement data 110 directly from patient support apparatus server 84 (or server 86). Alternatively, or additionally, server 84 may send updates to location data to one or more patient support apparatus 20 with instructions to forward this data to one or more specific location beacons 60 when the patient support apparatus 20 comes within a threshold distance of the location beacon (e.g. within communication range, within a defined distance, etc.).

The combination of patient support apparatuses 20 and server 84 (or 86) therefore collectively provide a mapping service in which the locations at which high impact forces commonly occur are detected by one or more patient support apparatuses 20, analyzed by server 84 (or 86), and transmitted back to the patient support apparatuses 20 (or location beacons 60) so that, when a patient support apparatus 20 travels through or near the high impact location in the future, the patient support apparatus 20 can automatically steer around the high impact location and/or reduce its speed while traveling through the high impact location. The result is that the impact forces will either be avoided or reduced when patient support apparatuses 20 travel through the high impact location.

As was noted, server 84 (or 86) may compares an impact location it receives from a patient support apparatus 20 to previous impact locations that were previously reported to it by the same, or other, patient support apparatuses. In some versions, server 84 or 86 may determine an impact location is a high impact location if high impact forces were previously detected at the same location. In other versions, server 84 or 86 may be configured to require more than two high impact forces to be detected at the same location before classifying the impact location as a high impact location. In still other versions, server 84 or 86 may take into account the severity of the impact, the time of the impact, and/or other factors when determining whether to classify an impact location as a high impact location (and thus reporting it to other patient support apparatuses 20). Still further, in some versions, the above-described function of server 84 or 86 may be performed, either wholly or partially, by controller 70 of each patient support apparatus 20.

Still further, in addition adding high impact locations to an internal map stored by server 84 or 86, server 84 or 86 may be configured to remove high impact locations from the internal map if a threshold number of patient support apparatuses 20 travel through the high impact location without detecting an impact force above the threshold. In other words, server 84 or 86 may be configured to not only add high impact locations to an internal map when one or more patient support apparatuses 20 detect high impact forces, but also to delete those high impact locations from the internal map when a threshold number of patient support apparatuses 20 do not detect high impact forces at those locations. In this manner, server 84 or 86 may dynamically update a map of the healthcare facility in a manner that helps avoid high impact forces and that also avoids unnecessary speed limits (and/or steering adjustments) through high impact locations that may have ceased to be high impact locations.

In any of the versions of patient support apparatuses 20 discussed herein, controller 70 may be configured to determine its orientation to structures within the healthcare facility (e.g. walls 62, location beacons 60, etc.) in one or more manners. For example, in some versions of movement system 150, both patient support apparatus 20 and location beacons 60 may include multiple location transceivers (74 and 102) that are spaced from each other on their respective device (20 or 60) and positioned at known locations. By ranging between these multiple location transceivers 74 and 102, the orientation of patient support apparatus 20 relative to a location beacon 60 may be determined. Further, through the use of magnetometers 68 and directional data that may be stored in location beacons 60, controller 70 may be able to determine the orientation of patient support apparatus 20 relative to a location beacon. Such directional data may indicate a geographic orientation of location beacon 60 and/or a wall (or other structure) to which it is attached. That is, movement data 110 may include data defining a geographic orientation (or an orientation defined with respect to another reference besides north) of the location beacon 60 and/or the wall to which it is attached.

Still further, controller 70 may be configured in some versions to determine both its floor speed and its relative speed to a location beacon and, if they are different, use the different to determine the heading of the patient support apparatus 20 relative to the location beacon 60.

In some versions, patient support apparatus 20 may also or alternatively determine its positioned and/or orientation within the healthcare facility by communicating with multiple location beacons 60. For example, each location beacon 60 may include data regarding the relative position of other location beacons 60 that are located nearby. In the example shown in FIG. 7, for instance, location beacon 60j may store information indicating that location beacon 60i is X meters north of beacon 60j, Y meters west of beacon 60o, and Z meters west of beacon 60p. Patient support apparatus 20 may range with multiple ones of these beacons 60i, 60j, 60o, and 60p, and, based on the distances from each of them, as well as their geographic orientation relative to each other, be able to determine its position and heading within the healthcare facility.

Controller 70 of patient support apparatus 20 may be configured to automatically use the movement data 110 it receives from one or more nearby location beacons 60 in multiple manners. When it comes to corner data, controller 70 may use this data to control the speed and/or steering of patient support apparatus 20 as the patient support apparatus 20 is moved around the corner, particularly when the patient support apparatus 20 is being driven by propulsion system 134. Indeed, in some versions of patient support apparatus 20, controller 70 only uses the movement data 110 while patient support apparatus 20 is being driven by propulsion system 134, while in other versions of patient support apparatus 20, controller 70 may use some or all of the movement data 110 while patient support apparatus 20 is being manually pushed by a caregiver.

With respect to intersection data, controller 70 may use this data to automatically reduce is maximum speed as patient support apparatus 20 approaches, and/or moves through, a particular intersection 164. With respect to speed limit data, controller 70 may use this data to automatically reduce its maximum speed while traveling through a corresponding speed limit area 166. In some versions, the speed limit area may be substantially co-extensive with the communication range of a particular location beacon 60, in which case controller 70 limits a maximum speed of patient support apparatus 20 while it is able to communicate with a particular location beacon 60. Controller 70 may limit this maximum speed by controlling driving motor 144 in a manner that limits the maximum speed of patient support apparatus 20 and/or by the application of one or more brakes on one or more of the wheels 24 of patient support apparatus 20.

With respect to corner data, controller 70 may use this data to automatically steer patient support apparatus 20 as it travels around the corresponding corner 162. This automatic steering may be beneficial for corners that have tight turning limits, narrow hallways, lots of foot traffic and/or patient support apparatus traffic, and/or for other types of corners.

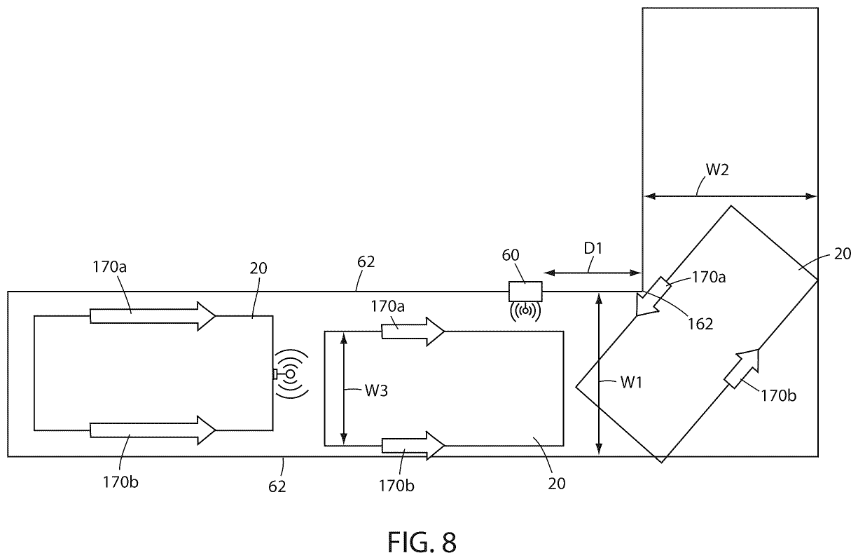

FIG. 8 illustrates one manner in which a patient support apparatus 20 may utilize corner data for a corner 162 having a high degree of sharpness and a narrow hallway width. That is, FIG. 8 illustrates a patient support apparatus 20 at three different moments in time as the patient support apparatus 20 steers around a corner 162. In the example shown in FIG. 8, location beacon 60 may not only inform patient support apparatus 20 of the distance D1 from location beacon 60 to corner 162, but also a width W1 of the hallway prior to the corner and a width W2 of the wall after the corner. Controller 70 uses this information, as well as a knowledge of the width W3 of patient support apparatus 20 itself to automatically control the steering of patient support apparatus 20 as it passes around corner 162. One manner in which controller 70 may use this corner data is to control the driving of two different powered wheels 140.

FIG. 8 illustrates two arrows 170a and 170b. Both arrows are vector arrows, meaning they have a length indicating an amount of driving force that is applied to a powered wheel 140 and a direction indicating a direction of the driving force that is applied. Arrow 170a corresponds to the driving force applied to a powered wheel 140 positioned on the inside (or left side in FIG. 8 when facing the direction of movement of patient support apparatus 20). Arrow 170b corresponds to the driving force applied to a powered wheel 140 positioned on the outside (or right side in FIG. 8 when facing the direction of movement of patient support apparatus 20).

Thus, it can be seen that, at a first moment in time (shown by the left-most position of patient support apparatus 20 of FIG. 8), controller 70 is driving both the inside and outside powered wheels at a relatively high and equal speed forward (to the right in FIG. 8). At a second moment in time (shown by the middle position of patient support apparatus 20 of FIG. 8), controller 70 has reduced the driving of both the inside and outside powered wheels, thereby causing patient support apparatus 20 to slow down its speed as it approaches corner 162. At a third moment in time (shown by the right position of patient support apparatus 20 of FIG. 8), controller 70 has continued to reduce the driving force applied to the outside powered wheel 140, and has applied a reverse driving force to the inside powered wheel 140. This simultaneous application of a rearward and forward force to the inside and outside powered wheels 140, respectively, causes patient support apparatus 20 to rotate (counterclockwise in FIG. 8) in a tighter manner than it would were the inside powered wheel to be driven forward, or allowed to remain neutral. In other words, controller 70 uses the movement data received from location beacon 60 to make a tighter turn around corner 162 without bumping into any walls.

In some versions of patient support apparatus 20, controller 70 makes the steering adjustments on top of those applied by the caregiver using driving propulsion control 142. In these versions, controller 70 will react to the instructions implemented by the caregiver using propulsion control 142, but will constrain such instructions to fit within a turn like the one shown in FIG. 8 (i.e. a tight turn that avoids walls 62. Thus, if the caregiver doesn't manually steer patient support apparatus 20 tight enough to make the turn shown in FIG. 8, controller 70 will turn the patient support apparatus 20 more tightly. Similarly, if the caregiver manually tries to steer patient support apparatus 20 too tightly around corner 162, controller 70 will automatically relax the steering so that the turn is not too tight. And, if the caregiver is using control 142 to implement a speed that is too fast for turning the corner at the desired level of tightness and without hitting any walls 62, controller 70 will automatically slow down one or more powered wheels 140 in order to carry out the desired turn.

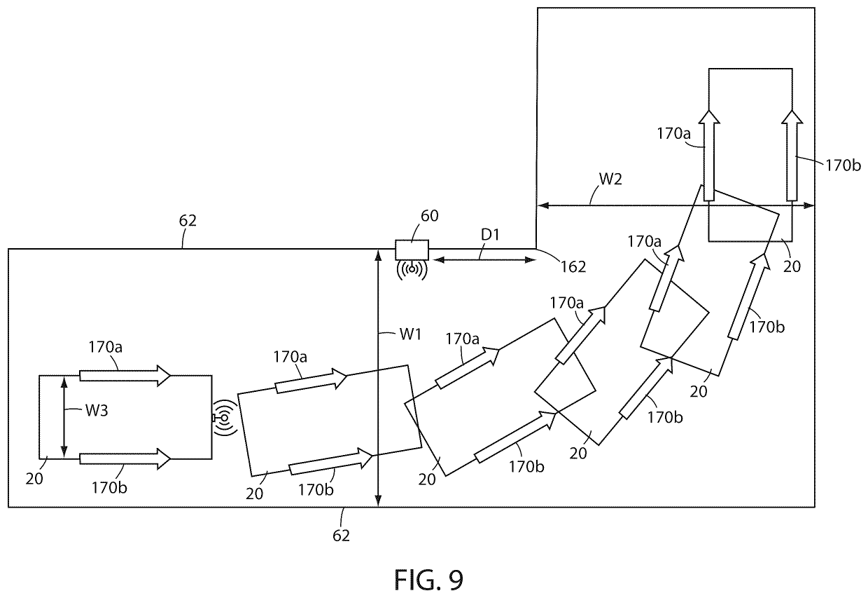

FIG. 9 illustrates one manner in which a patient support apparatus 20 may utilize corner data for a corner 162 having a ninety-degree angle but relatively wide hallway widths W1 and W2. As with FIG. 8, FIG. 9 illustrates a patient support apparatus 20 at multiple different moments in time as the patient support apparatus 20 steers around corner 162. Location beacon 60 may not only inform patient support apparatus 20 of the distance D1 from location beacon 60 to corner 162, but also width W1 of the hallway prior to the corner and width W2 of the wall after the corner. Controller 70 uses this information, as well as a knowledge of the width W3 of patient support apparatus 20 itself to automatically control the steering of patient support apparatus 20 as it passes around corner 162. The forces applied to the powered wheels 140 as the patient support apparatus 20 is moves around corner 162 are shown by arrows 170a (inside powered wheel) and 170b (outside powered wheel).

As can be seen in FIG. 9, controller 70 reduces the amount of forward driving force applied to the inside driven wheel 140 (as indicated by arrows 170a), but does not apply a reverse driving force to the inside driven wheel at any time (unlike the situation of FIG. 8). Controller 70 also reduces the amount of forward driving force applied to the outside driven wheel 140 as patient support apparatus 20 rounds the corner (as indicated by arrows 170b), but it does not reduce this force as much as it reduces the force applied to the inside driven wheel 140. In other words, controller 70 reduces the driving force applied to both the inside and outside wheels as patient support apparatus 20 is moved around the corner, but it reduces the force applied to the inside driven wheel 140 more than it does to the outside driven wheel 140.

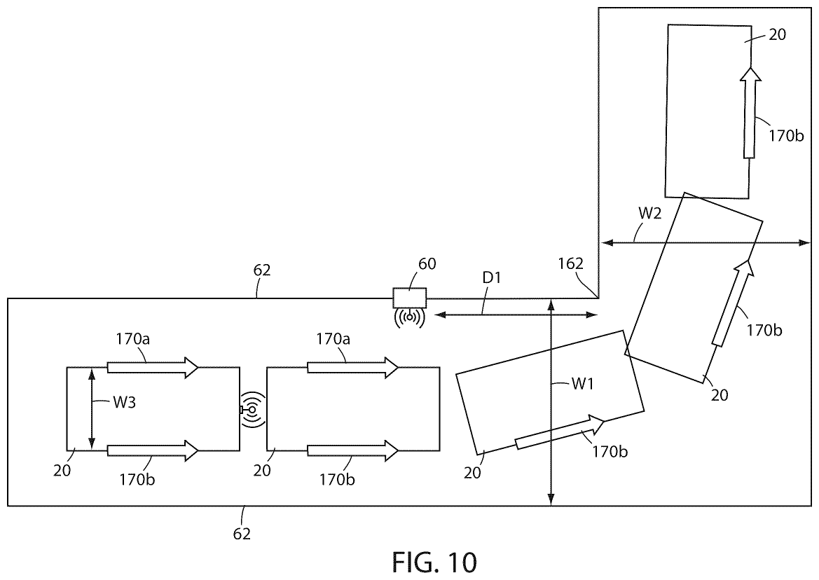

FIG. 10 illustrates one manner in which a patient support apparatus 20 may utilize corner data for a corner 162 having a ninety-degree angle but hallway widths W1 and W2 that are greater than those shown in FIG. 9, but smaller than those shown in FIG. 9. In other words, corner 162 of FIG. 10 has a degree of sharpness that is less than that of FIG. 8, but more than that of FIG. 9. In this particular example (FIG. 10), controller 70 applies forces to the inside and outside driven wheels 140 in the manner indicated by arrows 170a and 170b. As can be seen, controller 70 stops applying both a forward and a rearward force to the inside wheel (arrow 170a) as the patient support apparatus 20 turns corner 162, thereby allowing the inside wheel to freely spin. In contrast, controller 70 applies a force to the outside powered wheel (indicated by arrow 170b) that may be substantially constant throughout the turn, or it may be slightly reduced, depending upon the relative widths W1, W2, and W3, as well as the angle of corner 162.

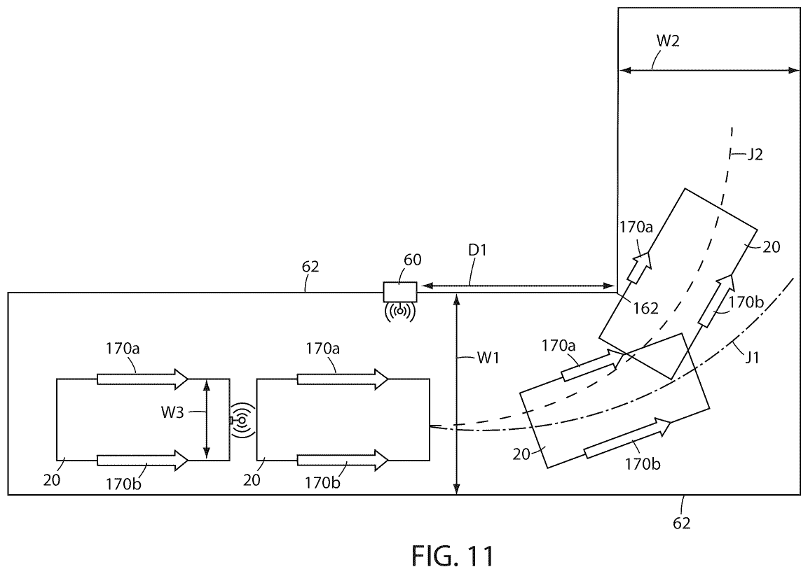

FIG. 11 illustrates one manner in which a patient support apparatus 20 may utilize corner data in order to calculate a path trajectory J1 (or J2) and to adjust its steering based on the calculated path trajectory. Although not illustrated in FIGS. 8-10, controller 70 may still implement the path trajectory calculations, like those shown in FIG. 11, for situations like those shown in FIGS. 8-10 and use those trajectory calculations to control the driving and steering of patient support apparatus 20 so at to avoid walls 62 and drive around the corner in a safe and efficient manner. In the example shown in FIG. 11, location beacon 60 wirelessly transmits it corner data to patient support apparatus 20 and that corner data includes the angle of corner 162, the width W1 and W2 of the hallways, and, in some instances, additional data. Controller 70 of patient support apparatus 20 repetitively determines is position and orientation relative to location beacon 60 (and thus corner 162) as it moves around corner 162. Based upon its current speed and heading, controller 70 calculated an estimated trajectory of J1 the movement of patient support apparatus 20 as it rounds the corner, assuming the same steering angle and speed are maintained. If this trajectory takes patient support apparatus 20 into a wall 62, such as shown by the trajectory J1 in FIG. 11, controller 70 automatically adjusts its speed and/or steering so that such a collision is avoided. Controller 70 then calculates a new trajectory, such as trajectory J2, based on the adjusted speed and/or steering. If that trajectory avoids the walls 62 and meets any other criteria that controller 70 may impose upon the turn, controller 70 maintains the current speed and/or steering so as to follow trajectory J2. Thus, controller 70 repetitively calculates its speed, position, orientation, and trajectory as it travels around corner 162 and, as necessary, makes the appropriate adjustments in order to avoid collision with any walls 62 (and/or other obstacles that might be identified in the movement data 110).

Corner data 110 may also include data indicating a desired sharpness of the turn around a corner, the side of the hallway patient support apparatus 20 should be on while it travels around the corner, a mid-line through the hallway that is desirably not crossed (so as to not occupy space that pedestrian traffic or patient support apparatus traffic going the opposite direction might utilize), and/or other data about the corner 162. Controller 70 then uses this data when it calculates its trajectory and, if necessary, makes adjustments to its speed and/or direction in order to meet any other criteria of the turn set forth in this additional corner data.

It will be understood by those skilled in the art that the use of the term “transceiver” throughout this specification is not intended to be limited to devices in which a transmitter and receiver are necessarily within the same housing, or share some circuitry. Instead, the term “transceiver” is used broadly herein to refer to both structures in which circuitry is shared between the transmitter and receiver, and transmitter-receivers in which the transmitter and receiver do not share circuitry and/or a common housing. Thus, the term “transceiver” refers to any device having a transmitter component and a receiver component, regardless of whether the two components are a common entity, separate entities, or have some overlap in their structures.

Various additional alterations and changes beyond those already mentioned herein can be made to the above-described embodiments. This disclosure is presented for illustrative purposes and should not be interpreted as an exhaustive description of all embodiments or to limit the scope of the claims to the specific elements illustrated or described in connection with these embodiments. For example, and without limitation, any individual element(s) of the described embodiments may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Any reference to claim elements in the singular, for example, using the articles “a,” “an,” “the” or “said,” is not to be construed as limiting the element to the singular.

What is claimed is:

1. A patient support apparatus comprising:
a plurality of wheels;
a support surface adapted to support a patient thereon;
a first wireless transceiver adapted to range with a location beacon mounted at a fixed location within a healthcare facility and to determine a distance between the patient support apparatus and the location beacon;
a network transceiver adapted to wirelessly communicate with a server;
an accelerometer adapted to detect when the patient support apparatus experiences an impact force while the patient support apparatus is moving; and
a controller adapted to transmit a message to the server via the network transceiver in response to the accelerometer detecting an impact force above a threshold, the message including location data indicating a relative position of the patient support apparatus to the location beacon when the accelerometer detected the impact force above the threshold.

2. The patient support apparatus of claim 1 wherein the controller is further adapted to determine a direction of travel of the patient support apparatus relative to the location beacon at the moment the impact force above the threshold is detected.

3. The patient support apparatus of claim 1 further including a second wireless transceiver adapted to range with the location beacon and to determine a second distance between the patient support apparatus and the location beacon.

4. The patient support apparatus of claim 1 further including a motor adapted to drive a powered wheel of the plurality of wheels.

5. The patient support apparatus of claim 4 further including a memory in which the controller is adapted to store an impact location indicating a location of the patient support apparatus at the moment when the impact force above the threshold was detected, wherein the controller is further adapted to compare the location data to past data stored in the memory, the past data including location information regarding prior detections of impact forces over the threshold.

6. The patient support apparatus of claim 5 wherein, if the controller detects past data indicating an impact force above the threshold was previously detected at the same location as the impact location, the controller is further adapted to automatically slow down the powered wheel in the future in response to the patient support apparatus moving to the same location as the impact location.

7. The patient support apparatus of claim 1 further including a first motor adapted to drive a powered wheel of the plurality of wheels and a second motor adapted to steer the patient support apparatus, wherein the controller is further adapted to receive steering data from the location beacon relating to steering of the patient support apparatus and to control the second motor in response to receipt of the steering data from the location beacon.

8. The patient support apparatus of claim 4 wherein the controller is further adapted to receive intersection data, corner data, and speed limit data from the location beacon, the intersection data relating to an intersection near the location beacon and informing the controller of a location of the intersection relative to the location beacon, the corner data relating to a corner near the location beacon and informing the controller of a degree of sharpness of the corner, and the speed limit data instructing the controller limit a speed of the powered wheel.

9. The patient support apparatus of claim 4 wherein the controller is further adapted to determine a first speed at which the powered wheel is moving and a second speed at which the distance between the patient support apparatus and the location beacon is changing.

10. The patient support apparatus of claim 4 wherein the first wireless transceiver is further adapted to range with a second patient support apparatus and to determine a second distance between the patient support apparatus and the second patient support apparatus.

11. The patient support apparatus of claim 10 wherein the controller is further adapted to perform at least one of the following: (1) determine a speed and direction of movement of the patient support apparatus within the healthcare facility and, if the second distance is less than a threshold, to transmit the speed and direction of movement to the second patient support apparatus; or (2) receive a speed and direction of movement of the second patient support apparatus within the healthcare facility and, if the second distance is less than a threshold, to adjust at least one of a speed or steering of the patient support apparatus.

12. The patient support apparatus of claim 1 wherein the first wireless transceiver is an ultra-wideband (UWB) transceiver adapted to range with the location beacon using UWB signals, and the patient support apparatus further includes a magnetometer adapted to be used by the controller to determine a geographic direction of travel of the patient support apparatus.

13. A system for sharing travel information in a healthcare facility, the system comprising a patient support apparatus, a location beacon, and a server;
wherein the patient support apparatus includes:
(i) a plurality of wheels;
(ii) a support surface adapted to support a patient thereon;
(iii) a first wireless transceiver adapted to range with the location beacon and to determine a distance between the patient support apparatus and the location beacon;
(iv) a network transceiver adapted to communicate with the server;
(v) an accelerometer adapted to detect when the patient support apparatus experiences an impact force while the patient support apparatus is moving; and
(vi) a controller adapted to transmit a message to the server via the network transceiver in response to the accelerometer detecting an impact force above a threshold, message including location data indicating an impact location of the patient support apparatus relative to the location beacon when the accelerometer detected the impact force above the threshold; and
wherein the server is adapted to receive the message and store in a memory the location data.

14. The system of claim 13 wherein the controller is further adapted to determine a direction of travel of the patient support apparatus relative to the location beacon at the moment the impact force above the threshold is detected and to send the direction of travel to the server.

15. The system of claim 13 wherein the patient support apparatus further includes a motor adapted to drive a powered wheel of the plurality of wheels, and the server is further adapted to compare the location data to past data stored in the memory, the past data including location information regarding prior detections of impact forces over the threshold by the patient support apparatus and/or other patient support apparatuses.

16. The system of claim 15 wherein, if the server detects past data indicating an impact force above the threshold was previously detected at the same location as the impact location, the server is adapted to automatically send a message to message to the patient support apparatus, the message instructing the patient support apparatus to slow down the powered wheel in the future in response to the patient support apparatus moving to the same location as the impact location.

17. The system of claim 13 wherein the patient support apparatus further includes a motor adapted to drive a powered wheel of the plurality of wheel, and wherein the controller is further adapted to transmit location messages to the server indicating a current location of the patient support apparatus relative to the location beacon, the controller adapted to transmit the location messages regardless of a detection of any impact force.

18. The system of claim 17 wherein the server is further adapted, in response to receipt of at least one of the location messages, to transmit at least one of the following to the patient support apparatus: speed limit data or steering data; and wherein the controller is adapted to perform at least one of the following: limit a speed of the powered wheel in response to receipt of the speed limit data, or automatically adjust a steering of the patient support apparatus in response to receipt of the steering data.

19. The system of claim 17 wherein the server is further adapted to perform at least one of the following:
(1) transmit intersection data to the patient support apparatus relating to an intersection near the location beacon, the intersection data adapted to cause the controller to control a speed of the patient support apparatus when traveling through the intersection; or
(2) transmit corner data to the patient support apparatus relating to a corner near the location beacon, the corner data adapted to cause the controller to automatically assist in steering the patient support apparatus around the corner based on the corner data.

20. The system of claim 17 wherein the server is further adapted to perform at least one of the following:
(1) receive second location messages from a second patient support apparatus and to determine a distance between the patient support apparatus and the second patient support apparatus based upon the location messages and the second location messages; or
(2) determine a speed and direction of movement of the patient support apparatus within the healthcare facility and, if the second distance is less than a threshold, to transmit a current location of the patient support apparatus to the second patient support apparatus.
